(19) United States
(12) Patent Application Publication
(10) Pub. No.: US 2026/0203934 A1
(43) Pub. Date: Jul. 16, 2026

(54) BRIGHTNESS INVARIANT SUB-PIXEL ESTIMATION

(71) Applicant: QUALCOMM Incorporated, San Diego, CA (US)

(72) Inventors: Aashish KUMAR, Bangalore (IN); Bhargava Venkata CHINTALAPATI, Hyderabad (IN); Pushkar GORUR SHESHAGIRI, Bengaluru (IN); Gerhard REITMAYR, Del Mar, CA (US); Ajit Deepak GUPTE, Bangalore (IN)

(21) Appl. No.: 19/022,977

(22) Filed: Jan. 15, 2025

(51) Int. Cl. G06T 7/73; G06T 7/246; G06T 7/269; G06V 10/60; G06V 10/62; G06V 10/75

(52) U.S. Cl. CPC G06T 7/74; G06T 7/248; G06T 7/269; G06V 10/60; G06V 10/62; G06V 10/751

(57) ABSTRACT

Certain aspects of the present disclosure provide techniques for performing sub-pixel estimation. In some aspects, certain techniques may include obtaining a reference image patch; obtaining an image depicting an edge feature; performing matching between pixels of the image and the reference image patch to determine an initial location as a location of a target image patch, corresponding to the reference image patch, in the image; estimating one or more brightness variance parameters corresponding to a brightness variance between the reference image patch and the target image patch; estimating, based on the reference image patch and the target image patch based on the initial location, a motion vector that estimates location difference of the edge feature between the reference image patch and the target image patch; and determining an updated location as the location of the target image patch.

### INTRODUCTION

### Field of the Disclosure

Aspects of the present disclosure relate to sub-pixel motion estimation techniques, and more particularly, to techniques for accounting for brightness when performing sub-pixel estimation.

### DESCRIPTION OF RELATED ART

In many image processing and computer vision applications, it is common to track features, such as of objects, between images, also referred to as frames. For example, as a device capturing images moves or the object moves, the position of the object in the images may change. In certain examples, the images captured may be referred to as a sequence of images or frames in time (e.g., video), and features may be tracked between successive images of the sequence.

Example tracked features may include edges, corners, patterns, or other distinctive visual elements that remain relatively consistent despite changes in viewpoint of the device capturing the images or scene content of a scene imaged by the device. Accurate determination of how these features move or align across different images can be important for tasks like scene reconstruction, object recognition, camera stabilization, or navigation. As the complexity of image scenes and the diversity of imaging conditions continue to grow, the ability to handle variations in lighting, perspective, and background clutter has become increasingly important.

### SUMMARY

One aspect provides a method for performing sub-pixel estimation. The method may comprise obtaining a reference image patch depicting an edge feature; obtaining an image depicting the edge feature; performing matching between pixels of the image and the reference image patch to determine an initial location as a location of a target image patch, corresponding to the reference image patch, in the image; estimating, based on the reference image patch and the target image patch based on the initial location, one or more brightness variance parameters corresponding to a brightness variance between the reference image patch and the target image patch; estimating, based on the reference image patch and the target image patch based on the initial location, a motion vector that estimates location difference of the edge feature between the reference image patch and the target image patch; determining, based on the motion vector, an updated location as the location of the target image patch; and determining, based on the one or more brightness variance parameters, whether to further update the location of the target image patch.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a diagram illustrating an example environment and system architecture for identifying and refining the location of a feature in image data in accordance with aspects of the present disclosure.

FIG. 2 depicts a diagram illustrating details of a brightness and sub-pixel estimator for refining the alignment of a target image patch relative to a reference image patch in accordance with aspects of the present disclosure.

FIG. 3 depicts a diagram illustrating details of a brightness and sub-pixel estimator for refining the alignment of a target image patch relative to a reference image patch in accordance with aspects of the present disclosure.

FIG. 4 depicts an example process for generating a sub-pixel estimate of a target image patch location using a parabola fitting approach, in accordance with aspects of the present disclosure.

FIG. 5 depicts a block diagram illustrating an architecture of an image capture and processing system, in accordance with aspects of the present disclosure.

FIG. 6 depicts a diagram illustrating an architecture of an example extended reality (XR) system, in accordance with some aspects of the disclosure.

FIG. 7 depicts a block diagram illustrating an architecture of a simultaneous localization and mapping (SLAM) system.

FIG. 8 depicts an example method for performing sub-pixel estimation.

FIG. 9 depicts aspects of an example processing system.

### DETAILED DESCRIPTION

Aspects of the present disclosure provide apparatuses, methods, processing systems, and computer-readable mediums for performing brightness-invariant sub-pixel estimation of edge features in computer vision systems.

In computer vision systems, precise feature tracking may be important for applications such as extended reality (XR) devices, robotics, and autonomous navigation systems. Computer vision systems may detect and track distinct features within captured images, such as to build accurate environmental maps or maintain spatial awareness. For example, when a user wearing an XR headset moves through a room, the vision system may track features in the environment-such as doorframes, table edges, and wall corners, to determine precisely where the headset is positioned and oriented in space. While some vision systems may primarily track corner features, edge features, which may represent (e.g., significant) changes in image intensity, may provide more trackable features or points throughout a scene. For example, edge features may appear more frequently in typical environments (like the long edges of a doorframe or window) and may provide information about object boundaries and scene structure. For example, in a typical office environment, while there might be dozens of corner features at wall intersections or furniture corners, there could be hundreds of edge features along walls, furniture edges, and object boundaries, providing substantially more reference points for tracking.

Some feature tracking systems may face several technical challenges when processing edge features. In one example, some sub-pixel estimation techniques may assume constant brightness between images and image patches, where an image patch refers to a portion of an image, such as within a bounding box. Such an assumption may fail in real-world scenarios where lighting conditions vary due to shadows, reflections, or environmental changes. In another example, edge features may be more difficult to track precisely than corner features because measurements of edge features may be made for movements in one specific direction (e.g., across the edge) rather than in any direction. Unlike corner features, which can be tracked in any direction, edge features have an inherent ambiguity along their length. For instance, when tracking a vertical edge like a doorframe, a feature tracking system may reliably detect horizontal movements (left or right). In contrast, vertical movements along the edge may be difficult to determine because the edge looks the same when moved up or down. Accordingly, feature-tracking approaches may be adapted to measure movement in the direction perpendicular to the edge. However, movement in a direction perpendicular to the edge may be more sensitive to brightness variations and measurement errors than corner features. In a further example, accurate sub-pixel estimation may require significant computational resources, particularly when processing thousands of features in real-time applications. These challenges may result in degraded tracking accuracy, reduced spatial awareness, and compromised system performance.

Such as to address these challenges, aspects of the present disclosure are directed to techniques for brightness-invariant sub-pixel estimation using edge features. In some aspects, an approximate location of an edge feature in an image, referred to as an approximate edge feature location, may be obtained using a similarity-based matching technique, such as normalized cross-correlation (NCC) matching. A similarity-based matching technique may work by comparing a reference image patch including a depiction of the edge feature, and in some cases pixels around the edge feature, to find a similar depiction of the edge feature in the image, also referred to as a target image. In some cases, the similarity-based matching technique may account for lighting changes. The reference image patch may be defined by a user, for example, or using some other technique. For example, the reference image patch may be generated from a different image including a depiction of the edge feature.

For example, when tracking a doorframe edge, a small rectangular region (e.g., a reference image patch) containing the edge, such as from a reference image (e.g., a first image in a sequence), may be used to search for the most similar region (e.g., target image patch) in a target image (e.g., subsequent image in time). In some aspects, this initial match can establish a rough integer-level, also referred to as pixel level, position of where each edge feature has moved, such as by identifying a an initial pixel level location of the target image patch. In particular, pixel level matches may determine integer coordinates, such as (x,y), which may be the coordinate of an actual pixel in the image.

In some aspects, after finding these initial positions, a refinement technique may be used to determine a sub-pixel location of an edge feature (e.g., the target image patch including the edge feature) while accounting for changes in brightness. A sub-pixel location may determine non-integer (e.g., float) coordinates, such as (x1,y1) which may be a coordinate between pixels in an image.

In some aspects, a refinement technique may calculate a variance in the brightness between images (e.g., between a reference image and a target image) and, more specifically, between image patches (e.g., between a reference image patch and a target image patch). Calculation of such variance in the brightness may include estimation of one or more brightness variance parameters, such as scaling and/or offset factors for pixel intensity values (also referred to as brightness values, such as 0-255), between the images. In some aspects, the scaling factor (e.g., a multiplicative parameter “a” to adjust contrast) and/or an offset factor (e.g., an additive parameter “B” to shift intensity values), may correct differences in illumination between the reference image patch and the target image patch. For example, if a brightness of the target image patch is different than the brightness of the reference image patch, such as because the target image patch includes a shadow cast on the edge feature, while the reference image patch does not include the shadow, then this information of different brightness of each patch can be used, such as to adjust the brightness intensity of the target image patch based on the brightness intensity of the reference image patch and/or determine whether to perform additional iterations of refinement. More specifically, in some aspects, if pixel intensities in a target image patch (with values ranging from 0 to 255) appear 10% darker than those in the corresponding reference image patch, the scaling factor “α” could be approximately 1.1 to brighten the target image patch proportionally. Similarly, if a subtle shadow is present in the target image patch, causing pixel values to be reduced by about 20 intensity levels, an offset “β” of +20 can be applied to align the brightness levels with those of the reference image patch. As will be discussed, such calculation of variance in the brightness may improve the accuracy of determination of the location of the edge feature in the target image, which may improve object tracking accuracy, object detection, etc.

In some aspects, a refinement technique (e.g., additionally) may calculate a motion vector that estimates a location difference of the edge feature between the reference image patch and the target image patch. For example, the refinement technique may represent the (e.g., two-dimensional) displacement describing how far and in which direction the edge feature has moved between the reference image patch and the target image patch (e.g., assuming the patches represent the same coordinate space). In certain aspects, the motion vector can be estimated using a motion estimation technique, such as an adapted optical flow technique. Examples of motion estimation techniques may include Lucas-Kanade optical flow estimation or efficient second-order minimization (ESM). The location of the target image patch can be updated based on the calculated motion vector, such as to try to better align the edge features in the target image patch with the edge feature in the reference image patch. For example, the coordinates of the target image patch may be updated by the motion vector. The resulting coordinate may be sub-pixel level coordinates, thereby leading to more accurate sub-pixel location estimations of the edge feature.

In certain aspects, the refinement technique may calculate variance in brightness and the motion vector sequentially. For example, the refinement technique may first estimate brightness variance parameters between the reference image patch and the target image patch as defined at the initial location determined by the similarity-based matching technique. The refinement technique may then adjust the brightness of the target image patch using the determined brightness variance parameters to bring the brightness of the target image patch more in-line with the brightness of the reference image patch. The resulting target image patch with corrected brightness may be referred to as a corrected target image patch. The refinement technique may then use the corrected target image patch to calculate the motion vector for the edge feature. Use of the corrected target image patch may improve accuracy of calculation of the motion vector due to the representation of the edge feature being more similar between the reference image patch and the target image patch.

In certain aspects, the refinement technique may calculate variance in brightness and the target image patch and the motion vector jointly, such as by jointly solving for the variables using a set of equations. Jointly solving for the variables may improve accuracy and computational efficiency. In some aspects, the refinement technique may account for interdependencies between brightness adjustments and spatial displacements. Accordingly, and in some aspects, the refinement technique may reduce the number of iterative steps required and improve sub-pixel edge feature localization under varying lighting conditions.

In certain aspects, in either the sequential or joint determination of brightness variance and motion vector calculation, the refinement technique may be performed iteratively. For example, after the target image patch location is updated based on the calculated motion vector, the refinement technique can be performed again for the target image patch. In certain aspects, a stopping condition for stopping iterations of the refinement technique includes determining whether the error in pixel values between the reference image patch and a corrected target image patch (target image patch corrected by applying the one or more brightness variance parameters) from a previous iteration is either the same or less the error from a current iteration, indicating that there is no further improvement occurring in identification of the location of the edge feature.

In certain aspects, motion vector estimation may be limited to gradient directions that are perpendicular to the edge, thereby improving motion vector estimation accuracy.

In certain aspects, the similarity-based matching technique, such as to estimate pixel level location of the target image patch, as part of the matching, is configured to determine correlation scores for each of a plurality of potential locations for the target image patch. For example, in NCC matching, an NCC matching score is determined for each location of a plurality of locations in the image for the target image patch. A higher correlation score may refer to a higher likelihood the target image patch matches the reference image patch.

In some aspects, a (e.g., rapid) estimation method may approximate the sub-pixel position by fitting (e.g., using a 1D parabola fit) a simple curve (e.g., parabola) to the correlation scores of potential locations near (e.g., within a threshold distance), and optionally perpendicular to the edge direction, the location of the target image patch determined by the matching technique, such as near the location of the target image patch defined by the highest correlation score. The location represented by the maximum of the curve may be determined as the updated target image patch location. In certain examples, such an approximation can provide an immediate rough (e.g., sub-pixel) estimate of the location of the target image patch, such as when speed is a determining factor. In certain aspects, such an estimated location of the target image patch may be used. In certain aspects, it may be determined such estimated location of the target image patch is not accurate within a threshold, such as it is outside some pre-defined range (e.g., if the estimated location of the target image patch deviates by more than a specified number of pixels or a measured error metric from a known or expected position). If such estimated location of the target image patch is not accurate within a threshold, another technique as discussed herein may be used for edge feature location determination. As the curve fitting is computationally inexpensive, this may reduce computational requirements on average over many edge feature detections, such as by limiting how often more computationally intensive techniques are used.

Some techniques might use a (e.g., rapid) curve fitting estimation method for some features (e.g., less critical background features) while applying other edge detection techniques as described above to process other features, such as edges of greater importance or priority.

In some aspects, techniques discussed herein provide certain advantages. For example, a brightness-invariant subpixel estimation technique may provide accurate edge tracking under challenging lighting conditions, such as when a user moves between differently lit areas of a room or when shadows from moving objects affect the scene. Such an approach may improve the reliability of spatial tracking when compared to traditional methods that assume constant lighting conditions. In another example, a multi-tiered approach that combines a quick curve fitting with more precise estimation methods allows computational resources to be allocated more efficiently. For example, computation resources may be allocated based on the importance and characteristics of different edge features. A system may dedicate more processing power to accurately tracking nearby objects that affect immediate user interaction while using faster, approximate tracking for distant or less critical features.

Additionally, in some aspects, the ability to separate brightness variance estimation from motion calculation may benefit various hardware implementations. Some memory requirements can be reduced by breaking down the edge location estimation methods into smaller, more manageable computations. In some aspects, a joint estimation approach that simultaneously estimates both brightness variance and motion vector may provide improved accuracy for tracking scenarios. In some aspects, by constraining motion estimation to directions perpendicular to the edge, physically impossible or ambiguous tracking results that could occur from movement along the edge direction can be avoided. For example, when tracking a vertical doorframe, left-right movements might be acceptable, while up-down measurements would not be.

### Example Environment for Performing Sub-Pixel Estimation

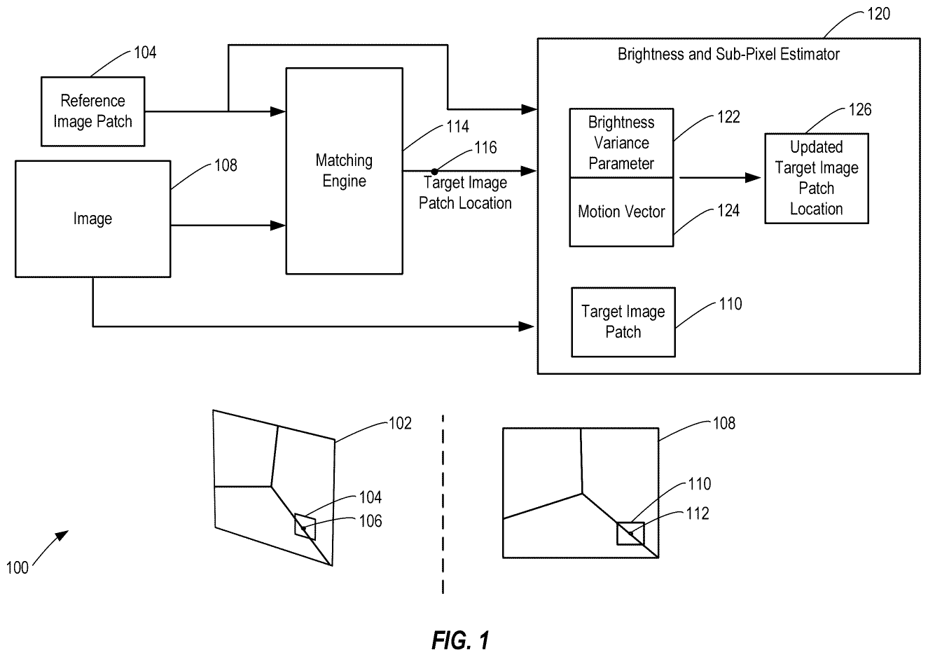

FIG. 1 depicts a diagram illustrating an example environment and system 100 for identifying and refining the location of a feature in image data in accordance with aspects of the present disclosure. In some aspects, the system 100 may be implemented in various forms of hardware, software, or a combination thereof, and may be particularly applicable to devices and systems involving real-time image processing and computer vision tasks. Such devices and systems may include, but are not limited to, augmented reality (AR) headsets, virtual reality (VR) systems, autonomous vehicles, drones, robotic arms, industrial inspection equipment, surveillance systems, and other platforms where precise image-based feature tracking and localization are desirable.

In some aspects, a reference image 102 may be initially obtained. In some aspects, the reference image 102 may be acquired through a camera, sensor, or any suitable imaging apparatus. In some aspects, the reference image 102 may correspond to a previously captured frame stored in a memory. In other aspects, the reference image 102 may represent a known template image associated with a certain object or scene. In some aspects, the reference image 102 may be the baseline or template against which subsequently captured images are compared.

In some aspects, such as within the reference image 102 is a reference image patch 104 may be obtained, such as identified and extracted. In some aspects, the reference image patch 104 may be a rectangular (or otherwise shaped) subset of pixel data selected to include a feature or set of features. The selection of the reference image patch 104 may be based on known feature detection algorithms or corner/edge extraction methods to determine regions of interest. Once obtained, the reference image patch 104 may be stored or otherwise made available for matching against future target images.

In some aspects, within the reference image patch 104 is an example feature 106. In some aspects, the example feature 106 may be representative of a visual element within the reference image patch 104 that can be tracked or aligned across multiple images. The example feature 106 may be an edge, corner, line, intersection, or other detectable structure. For example, the example feature 106 may represent the boundary of a doorframe, a window edge, a pattern on a wall, a textual character printed on a surface, or any other visual cue that stands out from its immediate surroundings. By selecting the reference image patch 104 that includes the example feature 106, the system establishes a point of reference that can be searched for in later frames or images, enabling the tracking of movements, changes in viewpoint, or object displacements.

As scenes evolve over time or as a camera moves, a new image, such as a target image 108, may be obtained. In some aspects, the target image 108 may represent the same general scene as the reference image 102, but from a different perspective, at a different time, or under different environmental conditions. For instance, lighting might have changed due to movement of a light source, the camera's exposure settings might differ, or an object of interest might be partially occluded. Such variations may introduce challenges when attempting to locate and align the example feature 106 in the target image 108.

In some aspects, within the target image 108, the system 100 operates to identify a target image patch 110 that corresponds to the reference image patch 104. In some aspects, a matching engine 114 may perform normalized cross-correlation (NCC) or other similarity-based matching techniques to find a region in the target image 108 that (e.g., most closely) matches (e.g., pixel values match) the reference image patch 104. The matching engine 114 may provide a target image patch location 116 indicating where, in the target image 108, a target image patch 110 similar to the reference image patch 104 is found. The target image patch 110 may contain an example feature 112. In some aspects, the example feature 112 may correspond to the example feature 106 from the reference image patch 104; however, due to variations between the reference image 102 and the target image 108 that may include shifts in brightness, perspective distortion, or other imaging artifacts, the alignment of the target image patch 110 to the reference image patch 104 is likely not perfect. In some aspects, the target image patch location 116 may be an integer/pixel-level location, based on the similarity-based matching technique. In some aspects, simply matching at an integer pixel level may not provide the sub-pixel accuracy desired for higher precision tasks. That is, the target image patch 110 might be close to the reference image patch 104, but still slightly misaligned in one or more dimensions.

As discussed above, the matching engine 114 may perform NCC to find a region in the target image 108 that matches the reference image patch 104. In some aspects, NCC is a mathematical approach used to measure the similarity between two image patches: one from the reference image (e.g., the reference image patch 104) and another from a candidate location in the target image 108. In some aspects, the NCC assigns a score to each target image patch evaluated, with scores ranging from −1 to +1, where +1 indicates a perfect match, 0 indicates no correlation, and −1 indicates a perfect negative correlation. By scanning over regions of the target image 108 that are the same size as the reference image patch 104, the system 100 computes NCC scores for each candidate region.

In some aspects, to compute NCC, both the reference and candidate patches are often mean-subtracted and, in some instances, normalized by their standard deviations. Normalization helps to ensure that the resulting correlation value is not influenced by absolute brightness differences or contrast variations, focusing instead on the pattern of intensity fluctuations within each patch. Thus, even if the lighting in the target image 108 differs somewhat from that in the reference image 102, NCC can still identify a patch with a similar structural pattern. In some aspects, once NCC scores are computed for various candidate locations, the matching engine 114 may select the location in the target image 108 that provides the highest NCC score. In some aspects, this location serves as an initial guess for where the reference image patch 104 may be found in the target image 108. Although NCC provides a relatively straightforward way to find a coarse match, NCC typically provides an alignment at integer pixel coordinates, which may not achieve the sub-pixel accuracy that certain applications desire.

In some aspects, after determining the match, the matching engine 114 may output a target image patch location 116. In some aspects, the target image patch location 116 indicates the coordinates in the target image 108 at which the patch most closely resembles the reference image patch 104 based on the NCC scores. In some aspects, this location is effectively a starting point for further refinement. For example, suppose the reference image patch 104 corresponds to a 20-by-20 pixel region that includes a distinctive vertical edge. In some aspects, the matching engine 114 may scan the target image 108, computing NCC scores for 20-by-20 candidates regions. After evaluating such candidate regions, the matching engine 114 may identify that the highest NCC score occurs for the patch located at pixel coordinates (x=250, y=360) in the target image 108. The pixel coordinate may represent a particular corner of the target image patch, which may have a defined size, for example. In this scenario, the target image patch location 116 may be set to (250, 360), indicating that a 20-by-20 region starting at these coordinates in the target image 108 best matches the reference image patch 104.

In some aspects, this target image patch location 116 may be an initial estimate, derived from NCC-based similarity measure. Although this initial match may place the patch at the correct region of the target image patch 110, the match may only achieve an integer-level accuracy. Additional processing steps, such as brightness compensation and sub-pixel refinement can be implemented based on the target image patch location 116 used as a starting point for further refinement.

In some aspects, the brightness and sub-pixel estimator 120 may perform additional processing to further align the reference image patch 104 and a target image patch 110. In some aspects, the brightness and sub-pixel estimator 120 takes as input the target image patch 110 as well as the reference image patch 104 (directly or indirectly) and iteratively refines the location of the target image patch 110 based on calculation of both one or more brightness variance parameters between the reference image patch 104 and target image patch 110 and a motion vector that estimates location difference of the feature 112 between the reference image patch 104 and the target image patch 110 to estimate the target image patch location with sub-pixel accuracy.

That is, in some aspects, the brightness and sub-pixel estimator 120 may be configured to improve the alignment between the reference image patch 104 and the target image patch 110 beyond simple pixel level matching techniques. In some aspects, the brightness and sub-pixel estimator 120 estimates, based on the reference image patch and the target image patch based on the initial location, one or more brightness variance parameters corresponding to a brightness variance between the reference image patch 104 and the target image patch 110. For example, the brightness and sub-pixel estimator 120 may determine differences in illumination between the reference image patch 104 and the target image patch 110, such as to avoid mismatches that might occur that are not due to actual feature displacements. In some aspects, by estimating and applying brightness variance parameters 122, the brightness and sub-pixel estimator 120 may normalize the intensity distributions between the reference image patch 104 and the target image patch 110 to compensate for changes in lighting, exposure, or reflectance conditions that might be present. Though indicated in the plural, there may be one or more brightness variance parameters 122.

In some aspects, the brightness and sub-pixel estimator 120 may also refine the motion vector that describes how the location of the target image patch 110 should be shifted (e.g., horizontally, vertically, or possibly with more complex transformations) within the target image 108 to achieve better alignment with the reference image patch 104. For example, the brightness and sub-pixel estimator 120 may be configured to estimate, based on the reference image patch 104 and the target image patch 110 based on the initial target image patch location 116, a motion vector 124 that estimates location difference of the edge feature between the reference image patch 104 and the target image patch 110. Using methods, such as but not limited to, Lucas-Kanade optical flow or efficient second-order minimization (ESM), that are specific to edge feature handling, the brightness and sub-pixel estimator 120 may iteratively adjust the motion vector 124 until the residual error e.g., the difference between the reference image patch 104 and a brightness-corrected target image patch is minimized. Unlike the initial integer-level alignment provided by the matching engine 114, the motion vector 124 may include fractional pixel values, thereby enabling sub-pixel accuracy.

For example, suppose the matching engine 114 has identified a target image patch location 116 at integer coordinates (x=250, y=360) within the target image 108. In some aspects, the brightness and sub-pixel estimator 120 may determine that a better possible fit to the reference image patch 104 can be achieved by shifting the target image patch 110 slightly beyond integer boundaries. During iterative refinement, the brightness and sub-pixel estimator 120 may compute that a horizontal shift of approximately +0.4 pixels and a vertical shift of about −0.2 pixels will reduce the residual error between the brightness-corrected target patch and the reference patch. In other words, rather than placing the target image patch 110 starting precisely at (250, 360), the brightness and sub-pixel estimator 120 may place the target image patch 110 at approximately (250.4, 359.8) which provides a more accurate match. This placement may correspond to the updated target image patch location 126 which may be used in a subsequent iteration.

Because such adjustments involve fractional pixel values, the motion vector 124 might read something similar to (Δx=+0.4, Δy=−0.2). Each iteration attempts incremental refinements to minimize the residual difference in intensities between the two image patches. Over several iterations, these fractional shifts may become subtle-such as adjusting from (0.4, −0.2) to (0.35, −0.18), until the residual error cannot be further reduced. Once convergence is reached, the resulting motion vector 124 may define the sub-pixel offset required to align the target image patch 110 with the reference image patch 104. In some aspects, convergence may refer to the point in the iterative refinement process where additional adjustments no longer decrease the differences between the target image patch 110 and the reference image patch 104. In some aspects, reaching convergence may indicate that a best-fit alignment between the target image patch 110 and the reference image patch 104 has been achieved.

### Example Brightness and Sub-Pixel Estimator

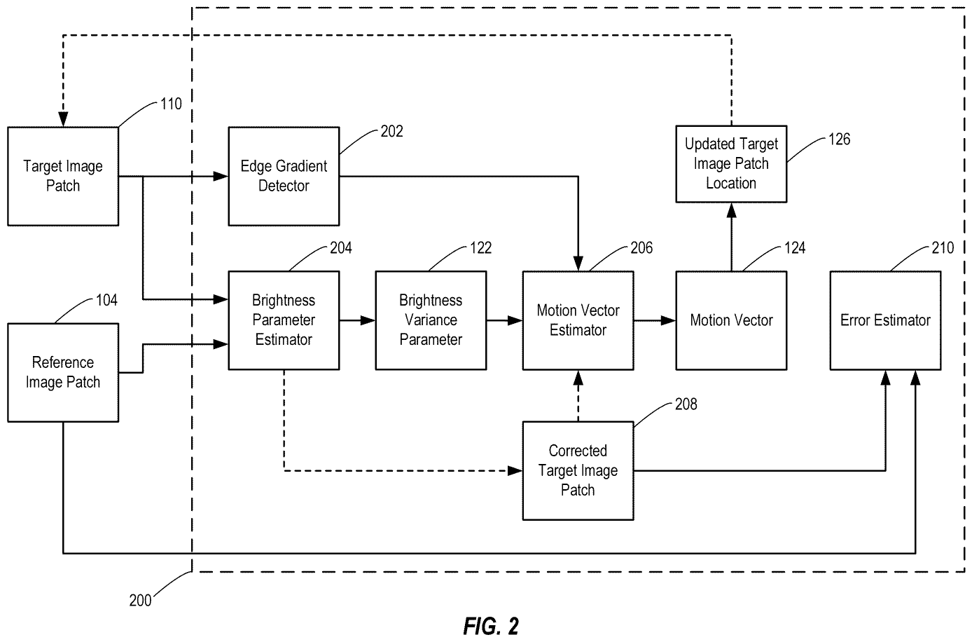

FIG. 2 depicts a diagram illustrating details of a brightness and sub-pixel estimator 200 for refining the alignment of a target image patch 110 relative to a reference image patch 104 in accordance with aspects of the present disclosure. The brightness and sub-pixel estimator 200 may be an example of, such as the same as or similar to the brightness and sub-pixel estimator 120 of FIG. 1. As depicted in FIG. 2, a target image patch 110 may be provided to the edge gradient detector 202 which may detect and provide as output, a gradient direction specific to an edge of a feature in the target image patch 110. In some aspects, the gradient direction of an edge within the target image patch may influence how a motion vector is estimated. In some aspects, the edge gradient detector 202 may analyze intensity gradients within the target image patch 110 to determine the orientation of feature edges. In some aspects, an edge gradient direction may refer to the orientation along which the rate of change in pixel intensity values is greatest, indicating the direction perpendicular to the edge itself. By identifying the direction of intensity changes, an edge gradient direction may be used to constrain how the motion vector is determined and/or updated. For instance, if a feature is known to be an edge aligned along a particular angle, the motion vector estimator 206 may incorporate this directional information to refine the sub-pixel shift along or perpendicular to the edge gradient direction as appropriate. In some aspects, the edge gradient detector 202 may utilize image processing techniques, such as applying Sobel or Scharr filters to compute an edge gradient direction.

In some aspects, the brightness and sub-pixel estimator 200 may include a brightness parameter estimator 204. The brightness parameter estimator 204 may receive both the reference image patch 104 and the target image patch 110. In some aspects, the brightness parameter estimator 204 may estimate the brightness variance parameters 122 to compensate for illumination differences between the target image patch 110 and the reference image patch 104. For example, if the target image patch 110 appears darker or lighter than the reference image patch 104, or if there is a bias in intensity values due to changes in exposure or lighting conditions, the brightness parameter estimator 204 may determine how to scale and shift the target patch's intensity distribution.

In some implementations, the brightness parameter estimator 204 may use a least-squares fitting approach or linear regression to determine an optimal scaling factor (multiplying pixel values of the target image patch 110 by a certain factor) and an additive offset (adding or subtracting a constant to pixel values of the target image patch 110). By adjusting the brightness variance parameters 122, the brightness parameter estimator 204 may change the intensity levels of the target image patch 110 such that they are closer to those of the reference image patch 104, thereby reducing the likelihood that differences in intensity would be misinterpreted as spatial misalignment between the target image patch 110 and the reference image patch 104.

In some aspects, the brightness variance parameter 122, as determined by the brightness parameter estimator 204, represents the scaling and offset values that, when applied to the target image patch 110, result in a corrected target image patch 208, which may be a brightness-corrected version of the target image patch 110. For example, if the target image patch 110 is 10% darker on average, the brightness variance parameters 122 might instruct the brightness and sub-pixel estimator 200 to increase pixel intensities in the target image patch 110 by 10% to obtain the corrected target image patch 208. Similarly, if there is a constant offset (e.g., due to a different black level), the brightness variance parameter 122 may specify adding or subtracting a specific value from each pixel.

In some aspects, the motion vector estimator 206 may receive the brightness variance parameter 122 and an edge gradient direction from the edge gradient detector 202. In some aspects, the motion vector estimator 206 may compute the motion vector 124 that describes how the target image patch 110 should be shifted, at sub-pixel granularity, to achieve a better match with the reference image patch 104. In some aspects, the motion vector estimator 206 may utilize various techniques to determine the motion vector 124. For instance, the motion vector estimator 206 could implement a Lucas-Kanade optical flow or an efficient second-order minimization (ESM) method. In some aspects, by leveraging the brightness-adjusted corrected target image patch 208 and the gradient edge direction, the motion vector estimator 206 may output the motion vector 124.

As previously described, the motion vector 124 may include a horizontal and vertical component (and, in some, more complex transformations) that position the bounding box of the target image patch 110 in the target image 108 (FIG. 1) at non-integer coordinates. In some aspects, the motion vector 124 represents the incremental displacement applied to the target image patch 110 such that the target image patch 110 matches the reference image patch 104. In some aspects, this displacement may be fractional, such as (Δx=0.37, Δy=−0.15), indicating that an updated target image patch is positioned slightly between pixels to achieve the best match.

In some aspects, once the brightness variance parameters 122 and the motion vector 124 are available, the brightness and sub-pixel estimator 200 may apply both adjustments to the target image patch 110 to obtain an updated target image patch location 126.

In some aspects, the error estimator 210 calculates the residual difference (error) between the corrected target image patch 208 and the reference image patch 104. This error might be computed as a sum of squared intensity differences, a sum of absolute differences, or another suitable metric. The error estimator 210 provides a quantitative measure of how well the current alignment matches the reference patch. In some aspects, the error estimator 210 calculates the residual difference (error) between the corrected target image patch 208, which may be based on the target image patch at the updated location (e.g., updated target image patch location 126) and the one or more brightness variance parameters

In some aspects, the result from the error estimator 210 may be used as a stopping criterion for further iterative refinements. In some aspects, if the error remains high, the brightness and sub-pixel estimator 200 can perform additional refinements. For example, the updated target image patch location 126 may be used to obtain the target image patch 110. The brightness parameter estimator 204 may re-compute brightness variance parameters 122 based on the target image patch 110 (e.g., new target image patch 110) and reference image patch 104. The edge gradient detector 202 may obtain an edge gradient direction, and the motion vector estimator 206 may output the motion vector 124. The error estimator 210 may monitor how close the corrected target image patch 208 is to the reference image patch 104. Over multiple iterations, as the brightness variance parameters 122 and the motion vector 124 are refined, the error measured by the error estimator 210 should decrease. In certain aspects, once the error falls below a certain threshold, the corrected target image patch 208 and the motion vector 124 may be at a suitable (e.g., best)-fit alignment, and the updated target image patch location 126 can be finalized. In certain aspects, once the error is no longer decreasing, the corrected target image patch 208 and the motion vector 124 may be at a suitable (e.g., best)-fit alignment, and the updated target image patch location 126 can be finalized.

After applying the brightness parameters and the motion vector to achieve reduced error, the brightness and sub-pixel estimator 200 outputs an updated target image patch location 126. This location provides the coordinates at which the target image patch better aligns with the reference image patch 104. Unlike the initial integer-level location obtained from a simple matching process, the updated target image patch location 126 accounts for brightness corrections and sub-pixel adjustments.

### Example Brightness and Sub-Pixel Estimator

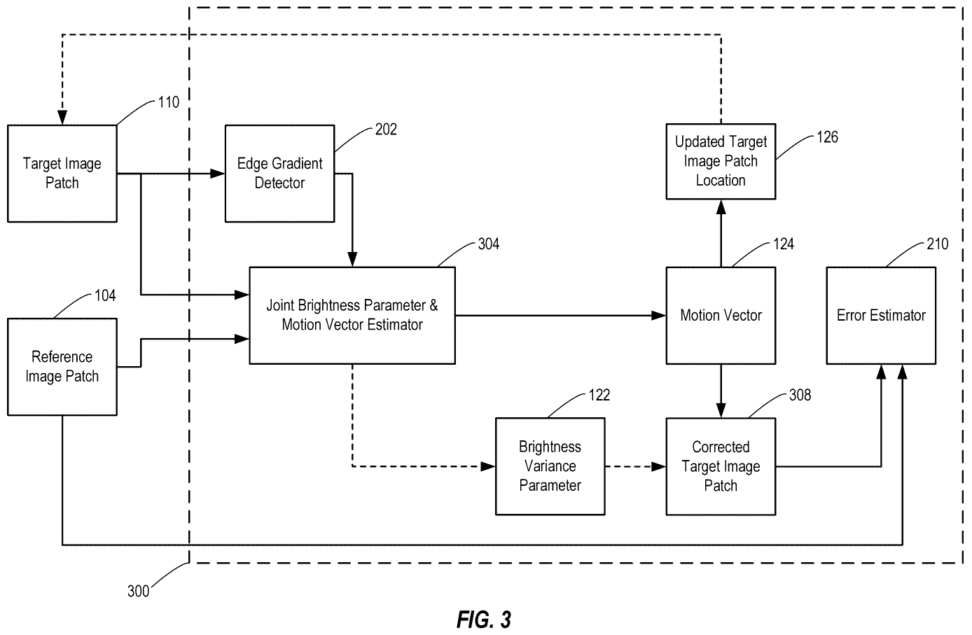

FIG. 3 depicts a diagram illustrating details of a brightness and sub-pixel estimator 300 for refining the alignment of a target image patch 110 relative to a reference image patch 104 in accordance with aspects of the present disclosure. In some aspects, FIG. 3 depicts how both brightness parameters and motion vectors may be estimated jointly by a single module, potentially improving efficiency and convergence speed.

As depicted in FIG. 3, a target image patch 110 and a reference image patch 104 are provided as inputs to the brightness and sub-pixel estimator 300. In some aspects, the edge gradient detector 202 takes as input the target image patch 110 and outputs a gradient edge direction as previously described with respect to FIG. 2. In some aspects, once the edge gradient detector 202 has determined the orientation and therefore the gradient direction of an edge feature within the target image patch 110, the edge gradient detector 202 may provide the gradient direction information to a joint brightness parameter & motion vector estimator 304. In some aspects, instead of estimating brightness and motion separately (as described in FIG. 2), the joint brightness parameter & motion vector estimator 304 utilizes a single component that jointly determines both brightness variance parameters 122 and the motion vector 124. By combining these estimations, the joint brightness parameter & motion vector estimator 304 can account for the interplay between brightness corrections and spatial alignment adjustments together.

In some aspects, the joint brightness parameter & motion vector estimator 304 receives inputs from both the reference image patch 104 and the target image patch 110, along with the edge gradient direction from the edge gradient detector 202. In some aspects, the joint brightness parameter & motion vector estimator 304 may simultaneously calculate the brightness variance parameters 122 (e.g., a brightness scaling parameter and an offset parameter) for sub-pixel displacements (the motion vector 124) that reduce (e.g., minimize) the residual error between the target image patch 110 and the reference image patch 104. For example, in some aspects, the joint brightness parameter & motion vector estimator 304 might employ iterative techniques that consider how adjusting brightness parameters affects the displacement of the feature within the target image patch, and how shifting the target image patch location changes the intensity differences between the two patches.

In some aspects, the brightness variance parameter 122, output by the joint motion vector estimator 304, represents the scaling and offset values applied to the target image patch's intensity distribution to better match that of the reference image patch 104. As previously described, these brightness variance parameters 122 may instruct the brightness and sub-pixel estimator 300 to multiply pixel values in the target patch by a certain factor or to add/subtract a constant intensity value. In some aspects, by making these brightness adjustments, the brightness and sub-pixel estimator 300 can reduce the risk that intensity differences caused by lighting variations will be interpreted as spatial misalignments between the target image patch 110 and the reference image patch 104.

In some aspects, the motion vector 124 determined by the joint brightness parameter & motion vector estimator 304 indicates how to shift the target image patch 110 at a sub-pixel level to better match the reference image patch 104. In some aspects, the motion vector 124 may utilize fractional pixel displacements along horizontal, vertical, or more complex directions.

In some aspects, once the brightness variance parameters 122 and the motion vector 124 are available, the brightness and sub-pixel estimator 300 may apply both adjustments to the target image patch 110 to obtain an updated target image patch location 126. In some aspects, the error estimator 210 calculates the residual difference (error) between the corrected target image patch 308 and the reference image patch 104. This error might be computed as a sum of squared intensity differences, a sum of absolute differences, or another suitable metric.

In some aspects, the result from the error estimator 210 may be used as a stopping criterion for further iterative refinements, as described with respect to FIG. 2. If the error remains high or has reduced further from a previous iteration, the brightness and sub-pixel estimator 300 can perform additional refinements. For example, the updated target image patch location 126 may be used to obtain the target image patch 110. The edge gradient detector 202 may obtain an edge gradient direction. The joint brightness parameter & motion vector estimator 304 may re-compute brightness variance parameters 122 and the motion vector 124 based on the target image patch 110 (e.g., new target image patch 110) and reference image patch 104. The error estimator 210 may monitor how close the corrected target image patch 308 is to the reference image patch 104. Over multiple iterations, as the brightness variance parameters 122 and the motion vector 124 are jointly refined, the error measured by the error estimator 210 should decrease. Once the error falls below a certain threshold or is no longer decreasing between successive iterations, the corrected target image patch 308 and the motion vector 124 may be in suitable (e.g., best-fit) alignment, and the updated target image patch location 126 can be finalized.

After applying the brightness parameters and the motion vector to achieve minimal error, the brightness and sub-pixel estimator 300 outputs an updated target image patch location 126. This location provides the final coordinates at which the target image patch (e.g., best) aligns with the reference image patch 104. Unlike the initial integer-level location obtained from a simple matching process, the updated target image patch location 126 accounts for brightness corrections and sub-pixel adjustments.

As previously described in FIG. 2, in some aspects, the error estimator 210 may evaluate the residual differences between the corrected target image patch 308 and the reference image patch 104. The error estimator 210 may compute a measure such as a sum of squared intensity differences or another error metric. By providing a numerical measure of alignment quality, the error estimator 210 enables iterative refinement. If the error is still too high or is still decreasing from a previous iteration, the joint brightness parameter & motion vector estimator 304 can adjust its parameters (both brightness and motion) and re-check the error. This iterative loop may continue until the error falls below a predetermined threshold or is no longer decreasing, indicating that the alignment is sufficiently accurate.

In some aspects, the joint brightness parameter & motion vector estimator 304 may employ techniques such as numerical optimization, gradient descent, Gauss-Newton, or Levenberg-Marquardt algorithms to search for a best combination of brightness parameters and motion vectors. By jointly optimizing these factors, the joint brightness parameter & motion vector estimator 304 can utilize dependencies between brightness and motion. For example, when brightness variations are properly accounted for, the system may find that the motion is less extensive than initially determined. Similarly, if precise motion estimation reveals that certain intensity discrepancies are due to spatial misalignment rather than global brightness shifts, the joint brightness parameter & motion vector estimator 304 can adjust brightness parameters accordingly.

In some aspects, FIG. 3 and the associated description provide an example of how brightness-invariant sub-pixel estimation may be formulated using a joint optimization approach based on Lucas-Kanade optical flow techniques, particularly suitable for edge features. In this approach, the target image patch intensities and motion parameters may be represented and refined through iterative updates to generate sub-pixel correction estimations under varying brightness conditions.

In some aspects, the intensity of the target image patch, denoted as I′(K, α, β) may be modeled in Equation (1) below:

$${I}^{′} ( K , α , β ) = α * I ( p ( K ) ) + β d \qquad Equation ( 1 )$$

In some aspects, α and β represent brightness-related parameters, such as a scaling factor and an additive offset, respectively. The term p(K) indicates a function p, dependent on a motion parameter K, which may define how pixel coordinates in the reference image patch map to coordinates in the target image patch. The motion parameter K may encode a motion vector (u, v) that shifts the patch location. For example, as expressed in Equations (2) and (3) below, the motion vector (u, v) may be constrained to move along the direction of the image gradient. Specifically, if (∇X, ∇Y) represents the spatial intensity gradients, the motion vector may be given by K*(∇X, ∇Y). In other words, the permissible motion direction is constrained to the gradient orientation such that sub-pixel displacements occur along feature edges.

$$p ( u , v ) = ( \begin{matrix}{p}_{x + u} \\ {p}_{y} + v\end{matrix} ) \qquad Equation ( 2 )$$

$$( \begin{matrix}u \\ v\end{matrix} ) = K ( \begin{matrix}∇ X \\ ∇ Y\end{matrix} ) \qquad Equation ( 3 )$$

$$p ( K ) = ( \begin{matrix}{p}_{x} + K ∇ X \\ {p}_{y} + K ∇ Y\end{matrix} ) \qquad Equation ( 4 )$$

The position p(K) may be represented as px+K*∇X and py+K*∇Y for horizontal and vertical components, as indicated, for instance, by Equations (3) and (4). Each variable involved—e.g., α, β, and K—may be considered a parameter to be estimated. In some aspects, Jacobians are computed with respect to each variable. The Jacobian computations, as illustrated by Equations (5)-(7), enable the determination of partial derivatives of the modeled intensity I′ with respect to K, α, and β. Such Jacobians are evaluated at each pixel within an N×N patch, such that the entire patch's intensity distribution contributes to the estimation process.

$$\frac{δ p}{δ K} = ( \begin{matrix}∇ X \\ ∇ Y\end{matrix} ) \qquad Equation ( 5 )$$

$$\begin{matrix}\frac{δ {I}^{′}}{δ K} = \frac{δ I}{δ p} * \frac{δ p}{δ K} & \frac{δ {I}^{′}}{δα} = I ( p ( K ) ) & \frac{δ {I}^{′}}{δβ} = 1\end{matrix} \qquad Equation ( 6 )$$

$$J = ( \begin{matrix}\frac{δ {I}^{′}}{δ K} & \frac{δ {I}^{′}}{δα} & \frac{δ {I}^{′}}{δβ} )\end{matrix} \qquad Equation ( 7 )$$

$$Δ s = {I}_{ref} - {I}^{′} \qquad Equation ( 8 )$$

$$Δ x = J ( x ) + Δ s \qquad Equation ( 9 )$$

$${x}_{new} + {x}_{old} + λ * Δ x \qquad Equation ( 10 )$$

Consistent with Lucas-Kanade optical flow evaluation, the pixel intensities in the target image patch may be evaluated to iteratively update the parameters based on these computed Jacobians and intensity differences. In some aspects, variables are updated using a learning rate λ, for example, in Equation (10). In some aspects, the residual error Δs (e.g., sum of squared differences (SSD) between the reference image patch and the corrected target image patch intensities) is to be minimized by adjusting a, β, and K. At each iteration, new parameter values (e.g., x_{new}=x_{old}+λ*Δx) move a solution toward minimizing the residual error.

In some aspects the iterative process may continue until the residual error Δs (e.g., Equation 8) cannot be further reduced, is below a threshold, or until a maximum number of iterations is reached. By applying these equations and iterative updates, a solution that produces both a brightness-invariant intensity alignment (through a and B) and a sub-pixel accurate motion vector K that aligns the reference image patch with the target image patch can be obtained.

In some aspects, when employing joint brightness-invariant sub-pixel estimation by using an Efficient Second-order Minimization (ESM) technique, both the brightness parameters and the motion parameters may be evaluated using a second-order approximation. In such aspects, Δx=2(J(e))+J(x))+Δs, where J(e) represents the Jacobian matrix associated with an error function.

### Example Process for Generating a Sub-Pixel Estimate Using a Parabola Fitting Approach

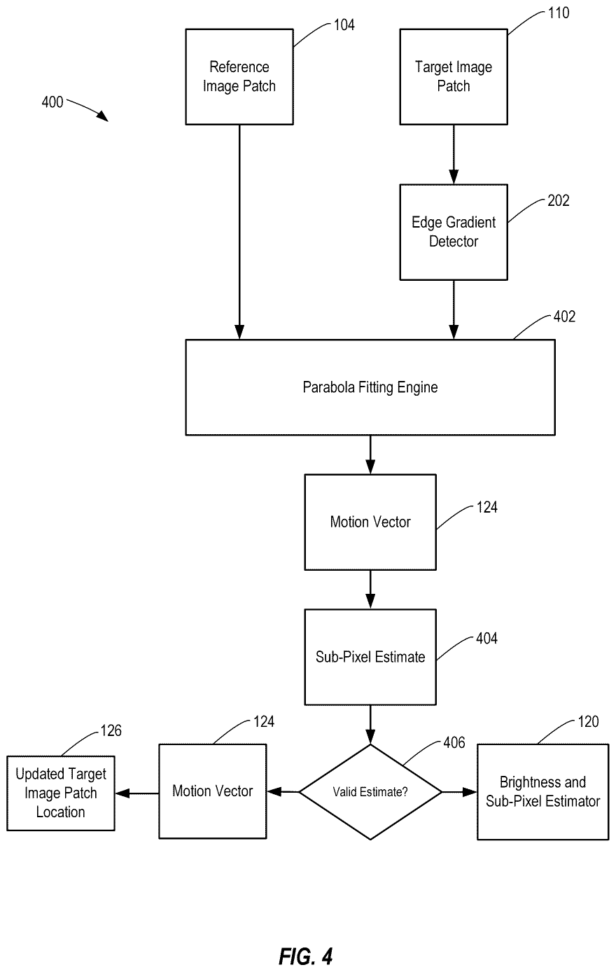

FIG. 4 depicts an example process 400 for generating a sub-pixel estimate of a target image patch location using a parabola fitting approach, in accordance with aspects of the present disclosure. As depicted in FIG. 4, the parabola fitting engine 402 can provide a preliminary sub-pixel estimate of the motion vector 124 and updated patch position without immediately using more computationally intensive iterative refinements. This approach may be advantageous in scenarios where processing resources are limited, or where a rapid, approximate alignment is acceptable.

As depicted in FIG. 4, a reference image patch 104 and a target image patch 110 are provided as inputs. In some aspects, the target image patch 110 may be provided to the edge gradient detector 202. The edge gradient detector 202 may analyze intensity changes within the target image patch 110 to determine the orientation of edges or linear features as previous described. In some aspects, the parabola fitting engine 402 receives the reference image patch 104, the target image patch 110, and the edge gradient direction. In some implementations, the parabola fitting engine 402 may compute normalized cross-correlation (NCC) or another similarity measure, referred to as correlation score, at discrete integer pixel shifts and then fit a parabola to these scores to estimate the optimal sub-pixel shift. In some examples, correlation scores corresponding to candidate target image patch positions along a particular direction (e.g., perpendicular to the edge direction) are computed. In some aspects, the parabola fitting engine 402, which may be implemented in hardware, software, or a combination thereof within a processing system, then fits a 1D parabola to these correlation scores and identifies a location at which the parabola attains its maximum value. The location at which the parabola attains its maximum value may correspond go the determined target image patch location. In some aspects, by examining how correlation scores vary near the edge gradient, the parabola fitting engine 402 can interpolate pixel locations to locate a sub-pixel displacement that provides a more accurate match between the target image patch 110 and the reference image patch 104.

In some aspects, the parabola fitting engine 402 outputs a motion vector 124 and a sub-pixel estimate 404. The motion vector 124 indicates how the target image patch 110 should be shifted relative to the reference image patch 104, while the sub-pixel estimate 404 represents the resulting location of the target image patch. In other words, rather than relying solely on integer pixel coordinates, the parabola fitting engine 402 can use fractional pixel offsets as a starting point (e.g., target image patch location 116 of FIG. 1).

In some aspects, a determination is made as to whether this sub-pixel estimate 404 is sufficiently accurate or “valid.” For example, at 406, a comparison can be performed based on whether the estimate from the parabola fitting engine 402 meets certain criteria, such as a low residual error or achieving a correlation score above a threshold. In some aspects, the correlation score may refer to a numerical measure indicating how closely two image patches resemble each other. In other words, the correlation score may quantity the similarity between the reference image patch and the target image patch. A higher correlation score suggests that the two patches are very similar in terms of their intensity patterns and structural features, while a lower correlation score indicates that they differ significantly. If the estimate is determined to be valid, the updated target image patch location 126 may be confirmed as the final sub-pixel alignment. In that case, the motion vector 124 and the updated target image patch location 126 can be passed on to downstream tasks, such as object tracking, augmented reality alignment, or camera pose estimation.

If, however, it is determined that the initial sub-pixel estimate 404 is not sufficiently accurate, the process 400 may proceed to a brightness and sub-pixel estimator 120. The brightness and sub-pixel estimator 120, as described in relation to FIGS. 1-2, may implement a more iterative refinement process. Although more computationally intensive, the brightness and sub-pixel estimator 120 may provide a more accurate motion vector and/or target image patch location if the parabola-based approach is inadequate.

By incorporating a fallback mechanism as depicted in FIG. 4, a faster, non-iterative method (parabola fitting) may produce a “good enough” sub-pixel estimate, saving time and processing power. In other cases, where conditions are more challenging, more sophisticated iterative refinements may be utilized, leveraging brightness compensation and motion estimation methods as previously discussed. Such a hierarchical approach can make better use of computational resources in varying lighting conditions without always resorting to the most computationally costly methods.

In some aspects, the choice of technique for estimating sub-pixel positions and brightness variance parameters may be based on an accuracy versus power consumption trade-off. For example, in some aspects, the joint optimization approach where brightness variance parameters and motion vectors are solved simultaneously may achieve the highest accuracy but may also require the greatest computational load and therefore consume the most power. A sequential solver that first determines brightness corrections and then refines the motion vector may provide less accuracy than the joint solver, but may consume less power. The one-dimensional parabola fitting technique may deliver a rapid, approximate solution with minimal power consumption, though at reduced accuracy. Accordingly, depending on a device's power constraints and the accuracy needed, a system can dynamically select between these techniques.

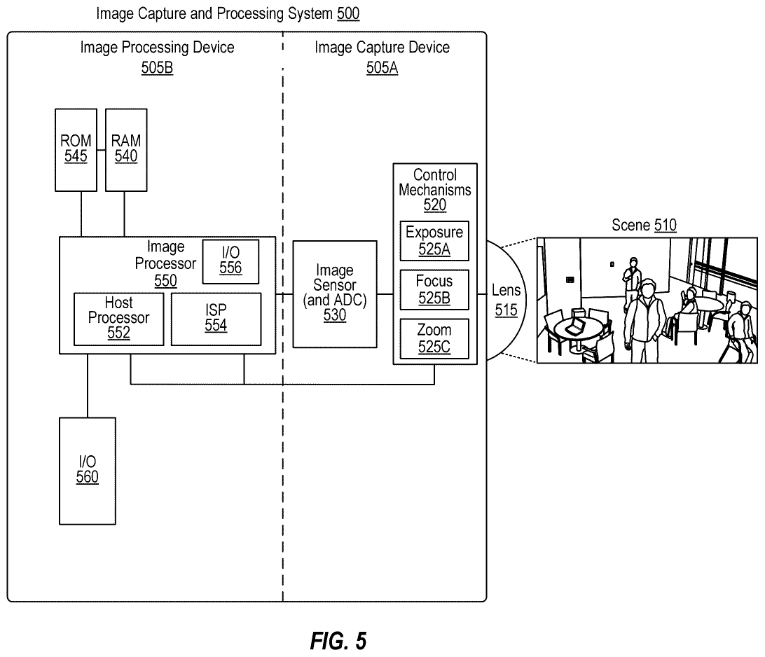

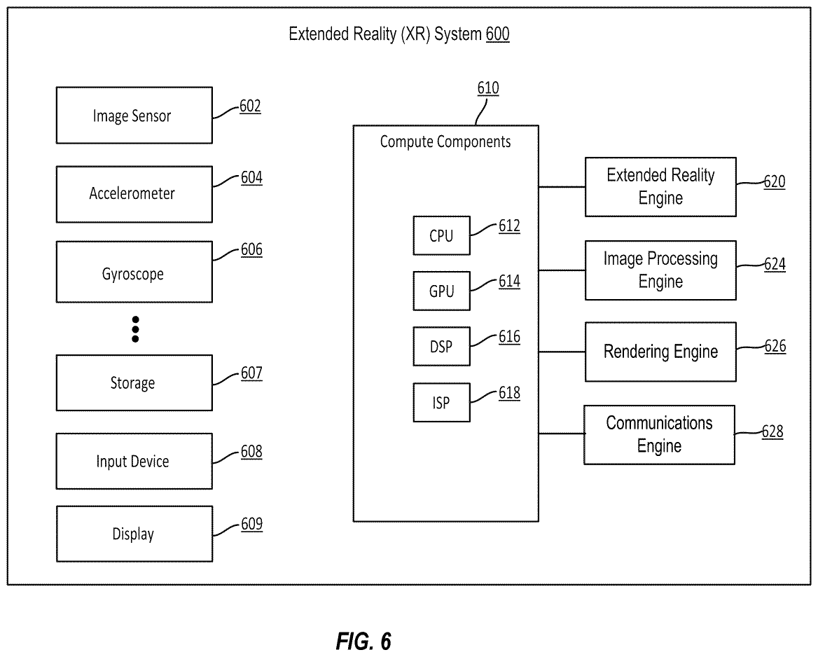

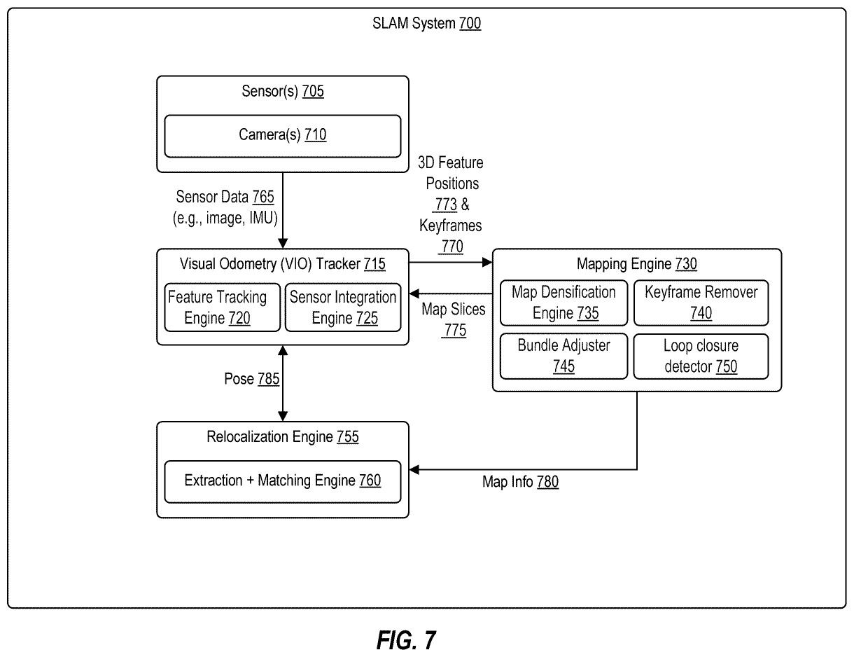

By applying brightness-invariant, sub-pixel feature estimation as illustrated in FIGS. 1-4, the techniques described can be integrated into larger image processing and computer vision pipelines. In the following sections, it will become apparent how these refined feature localization methods fit into end-to-end imaging systems, XR devices, and SLAM-based navigation frameworks. For instance, the sub-pixel refinement modules shown in FIGS. 1-4 can function as front-end processes that feed more accurate and robust feature data into the system-level architectures and components depicted in FIG. 5. Similarly, this brightness-invariant approach supports stable feature tracking in XR systems (FIG. 6) and precise camera pose estimation within SLAM systems (FIG. 7). By leveraging the initial image patches and sub-pixel refinements, the methods described here serve as critical building blocks for the downstream operations that yield robust, real-world performance across varied lighting conditions and complex environmental changes.

### Example Architecture of an Image Capture Device

FIG. 5 depicts a block diagram illustrating an architecture of an image capture and processing system 500 in accordance with aspects of the present disclosure. In some aspects, the image capture and processing system 500 may include various components that are used to capture and process images of scenes (e.g., an image of a scene 510). In some aspects, the image capture and processing system 500 can capture standalone images (or photographs) and/or can capture videos that include multiple images (or video frames) in a particular sequence. In some aspects, the lens 515 and image sensor 530 can be associated with an optical axis. In some aspects, the photosensitive area of the image sensor 530 (e.g., the photodiodes) and the lens 515 can both be centered on the optical axis. In some aspects a lens 515 of the image capture and processing system 500 may face a scene 510 and receive light from the scene 510. In some aspects, the lens 515 may bend incoming light from the scene toward the image sensor 530. The light received by the lens 515 passes through an aperture. In some aspects, the aperture (e.g., the aperture size) is controlled by one or more control mechanisms 520 and is received by an image sensor 530. In some aspects, the aperture can have a fixed size.

In some aspects, the one or more control mechanisms 520 may control exposure, focus, and/or zoom based on information from the image sensor 530 and/or based on information from the image processor 550. In some aspects, the one or more control mechanisms 520 may include multiple mechanisms and components; for instance, the control mechanisms 520 may include one or more exposure control mechanisms 525A, one or more focus control mechanisms 525B, and/or one or more zoom control mechanisms 525C. The one or more control mechanisms 520 may also include additional control mechanisms besides those that are illustrated, such as control mechanisms controlling analog gain, flash, HDR, depth of field, and/or other image capture properties.

In some aspects, the focus control mechanism 525B of the control mechanisms 520 can obtain a focus setting. In some aspects, the focus control mechanism 525B may store the focus setting in a memory register. Based on the focus setting, the focus control mechanism 525B can adjust the position of the lens 515 relative to the position of the image sensor 530. For example, In some aspects, and based on the focus setting, the focus control mechanism 525B can move the lens 515 closer to the image sensor 530 or farther from the image sensor 530 by actuating a motor or servo (or other lens mechanism), thereby adjusting focus. In some aspects, additional lenses may be included in the image capture and processing system 500, such as one or more microlenses over each photodiode of the image sensor 530, which each bend the light received from the lens 515 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 520, the image sensor 530, and/or the image processor 550. The focus setting may be referred to as an image capture setting and/or an image processing setting. In some aspects, the lens 515 can be fixed relative to the image sensor and focus control mechanism 525B can be omitted without departing from the scope of the present disclosure.

In some aspects, the exposure control mechanism 525A of the control mechanisms 520 can obtain an exposure setting. In some aspects, the exposure control mechanism 525A stores the exposure setting in a memory register. Based on this exposure setting, the exposure control mechanism 525A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 530 (e.g., ISO speed or film speed), analog gain applied by the image sensor 530, or any combination thereof. The exposure setting may be referred to as an image capture setting and/or an image processing setting.

In some aspects, the zoom control mechanism 525C of the control mechanisms 520 can obtain a zoom setting. In some examples, the zoom control mechanism 525C stores the zoom setting in a memory register. Based on the zoom setting, the zoom control mechanism 525C can control a focal length of an assembly of lens elements (lens assembly) that includes the lens 515 and one or more additional lenses. For example, the zoom control mechanism 525C can control the focal length of the lens assembly by actuating one or more motors or servos (or other lens mechanism) to move one or more of the lenses relative to one another. In some aspects, the zoom setting may be referred to as an image capture setting and/or an image processing setting. In some examples, the lens assembly may include a parfocal zoom lens or a varifocal zoom lens. In some examples, the lens assembly may include a focusing lens (which can be lens 515 In some aspects) that receives the light from the scene 510 first, with the light then passing through an afocal zoom system between the focusing lens (e.g., lens 515) and the image sensor 530 before the light reaches the image sensor 530. The afocal zoom system may, In some aspects, include two positive (e.g., converging, convex) lenses of equal or similar focal length (e.g., within a threshold difference of one another) with a negative (e.g., diverging, concave) lens between them. In some aspects, the zoom control mechanism 525C moves one or more of the lenses in the afocal zoom system, such as the negative lens and one or both of the positive lenses. In some aspects, zoom control mechanism 525C can control the zoom by capturing an image from an image sensor of a plurality of image sensors (e.g., including image sensor 530) with a zoom corresponding to the zoom setting. For example, image processing system 500 can include a wide angle image sensor with a relatively low zoom and a telephoto image sensor with a greater zoom. In some aspects, based on the selected zoom setting, the zoom control mechanism 525C can capture images from a corresponding sensor.

The image sensor 530 includes one or more arrays of photodiodes or other photosensitive elements. Each photodiode measures an amount of light that eventually corresponds to a particular pixel in the image produced by the image sensor 530. In some aspects, different photodiodes may be covered by different filters. In some aspects, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 5, other types of color filters may use yellow, magenta, and/or cyan (also referred to as “emerald”) color filters instead of or in addition to red, blue, and/or green color filters. In some aspects, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 530) may lack filters (e.g., color, IR, or any other part of the light spectrum) altogether and may instead use different photodiodes throughout the pixel array (In some aspects vertically stacked). The different photodiodes throughout the pixel array can have different spectral sensitivity curves, therefore responding to different wavelengths of light. Monochrome image sensors may also lack filters and therefore lack color depth.

In some aspects, the image sensor 530 may alternately or additionally include opaque and/or reflective masks that block light from reaching certain photodiodes, or portions of certain photodiodes, at certain times and/or from certain angles. In some aspects, opaque and/or reflective masks may be used for phase detection autofocus (PDAF). In some aspects, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). In some aspects, the image sensor 530 may also include an analog gain amplifier to amplify the analog signals output by the photodiodes and/or an analog to digital converter (ADC) to convert the analog signals output of the photodiodes (and/or amplified by the analog gain amplifier) into digital signals. In some aspects, certain components or functions discussed with respect to one or more of the control mechanisms 520 may be included instead or additionally in the image sensor 530. The image sensor 530 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

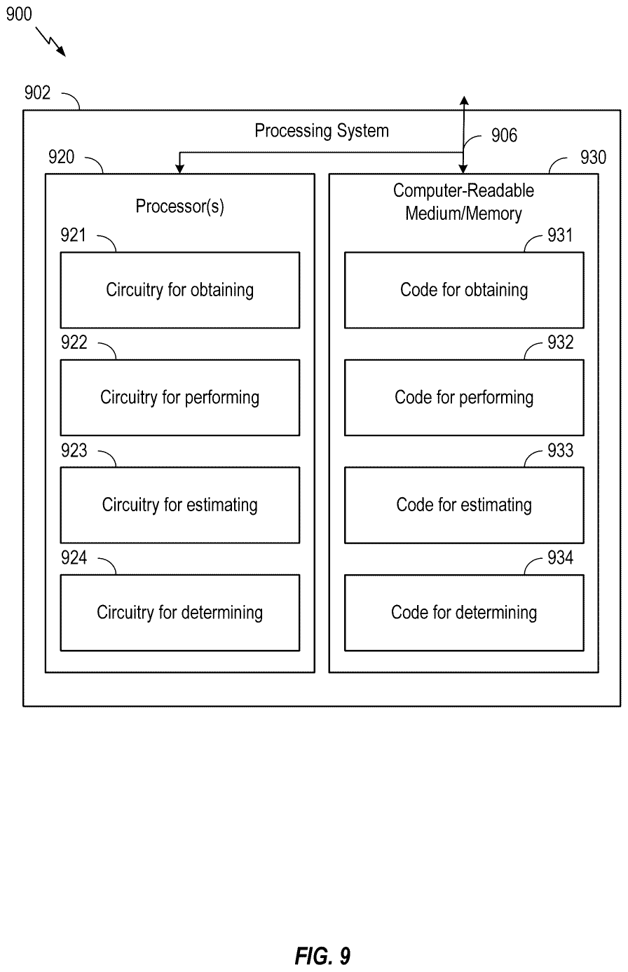

The image processor 550 may include one or more processors, such as one or more image signal processors (ISPs) (including ISP 554), one or more host processors (including host processor 552), and/or one or more of any other type of processor 920 of FIG. 9 discussed with respect to the processing system 900 of FIG. 9. The host processor 552 can be a digital signal processor (DSP) and/or other type of processor. In some implementations, the image processor 550 may be a single integrated circuit or chip (e.g., referred to as a system-on-chip or SoC) that includes the host processor 552 and the ISP 554. In some aspects, the chip can also include one or more input/output ports (e.g., input/output (I/O) ports 556), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. In some aspects, the I/O ports 556 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 552 may communicate with the image sensor 530 using an I2C port, and the ISP 554 can communicate with the image sensor 530 using an MIPI port.

In some aspects, the image processor 550 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 550 may store image frames and/or processed images in random access memory (RAM) 540, read-only memory (ROM) 545, a cache, a memory unit, another storage device, or some combination thereof.

Various input/output (I/O) devices 560 may be connected to the image processor 550. In some aspects, the I/O devices 560 can include a display screen, a keyboard, a keypad, a touchscreen, a trackpad, a touch-sensitive surface, a printer, any other output devices, any other input devices, or some combination thereof. In some aspects, a caption may be input into the image processing device 505B through a physical keyboard or keypad of the I/O devices 560, or through a virtual keyboard or keypad of a touchscreen of the I/O devices 560. In some aspects, the I/O devices 560 may include one or more ports, jacks, or other connectors that enable a wired connection between the image capture and processing system 500 and one or more peripheral devices, over which the image capture and processing system 500 may receive data from the one or more peripheral device and/or transmit data to the one or more peripheral devices. In some aspects, the I/O devices 560 may include one or more wireless transceivers that enable a wireless connection between the image capture and processing system 500 and one or more peripheral devices, over which the image capture and processing system 500 may receive data from the one or more peripheral device and/or transmit data to the one or more peripheral devices. The peripheral devices may include any of the previously-discussed types of I/O devices 560 and may themselves be considered I/O devices 560 once they are coupled to the ports, jacks, wireless transceivers, or other wired and/or wireless connectors.

In some aspects, the image capture and processing system 500 may be a single device. In some aspects, the image capture and processing system 500 may be two or more separate devices, including an image capture device 505A (e.g., a camera) and an image processing device 505B (e.g., a computing device coupled to the camera). In some aspects, the image capture device 505A and the image processing device 505B may be coupled together, for example via one or more wires, cables, or other electrical connectors, and/or wirelessly via one or more wireless transceivers. In some implementations, the image capture device 505A and the image processing device 505B may be disconnected from one another.

As shown in FIG. 5, a vertical dashed line divides the image capture and processing system 500 of FIG. 5 into two portions that represent the image capture device 505A and the image processing device 505B, respectively. In some aspects, the image capture device 505A includes the lens 515, control mechanisms 520, and the image sensor 530. The image processing device 505B includes the image processor 550 (including the ISP 554 and the host processor 552), the RAM 540, the ROM 545, and the I/O devices 560. In some aspects, certain components illustrated in the image capture device 505A, such as the ISP 554 and/or the host processor 552, may be included in the image capture device 505A.

In some aspects, the image capture and processing system 500 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 500 can include one or more wireless transceivers for wireless communications, such as cellular network communications, 802.11 wi-fi communications, wireless local area network (WLAN) communications, or some combination thereof. In some implementations, the image capture device 505A and the image processing device 505B can be different devices. For instance, the image capture device 505A can include a camera device and the image processing device 505B can include a computing device, such as a mobile handset, a desktop computer, or other computing device.

In some aspects, while the image capture and processing system 500 is shown to include certain components, one of ordinary skill will appreciate that the image capture and processing system 500 can include more components than those shown in FIG. 5. In some aspects, the components of the image capture and processing system 500 can include software, hardware, or one or more combinations of software and hardware. For example, in some aspects, the components of the image capture and processing system 500 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 500.

In some examples, the extended reality (XR) system 600 of FIG. 6 can include the image capture and processing system 500, the image capture device 505A, the image processing device 505B, or a combination thereof. In some examples, the SLAM system 700 of FIG. 7 can include the image capture and processing system 500, the image capture device 505A, the image processing device 505B, or a combination thereof.

In some aspects, the image capture and processing system 500 may incorporate the brightness-invariant, sub-pixel estimation techniques outlined in FIGS. 1-4 at the image processor level. For example, the brightness and sub-pixel estimator described above can be implemented within or alongside the ISP 554 and/or the host processor 552, ensuring that feature patches extracted from the raw sensor data undergo accurate brightness normalization and sub-pixel alignment. By doing so, the image processing system 500 can provide refined feature inputs to higher-level tasks-such as object detection, motion tracking, or scene mapping-resulting in more stable and reliable performance even as lighting conditions vary.

### Example Architecture of an Extended Reality System

FIG. 6 is a diagram illustrating an architecture of an example extended reality (XR) system 600, in accordance with some aspects of the disclosure. The XR system 600 can run (or execute) XR applications and implement XR operations. In some aspects, the XR system 600 can perform tracking and localization, mapping of an environment in the physical world (e.g., a scene), and/or positioning and rendering of virtual content on a display 609 (e.g., a screen, visible plane/region, and/or other display) as part of an XR experience. For example, the XR system 600 can generate a map (e.g., a three-dimensional (3D) map) of an environment in the physical world, track a pose (e.g., location and position) of the XR system 600 relative to the environment (e.g., relative to the 3D map of the environment), position and/or anchor virtual content in a specific location(s) on the map of the environment, and render the virtual content on the display 609 such that the virtual content appears to be at a location in the environment corresponding to the specific location on the map of the scene where the virtual content is positioned and/or anchored. The display 609 can include a glass, a screen, a lens, a projector, and/or other display mechanism that allows a user to see the real-world environment and also allows XR content to be overlaid, overlapped, blended with, or otherwise displayed thereon.

In some aspects, the XR system 600 includes one or more image sensors 602, an accelerometer 604, a gyroscope 606, storage 607, compute components 610, an XR engine 620, an image processing engine 624, a rendering engine 626, and a communications engine 628. It should be noted that the components 602-628 shown in FIG. 6 are non-limiting examples provided for illustrative and explanation purposes, and other examples can include more, fewer, or different components than those shown in FIG. 6. For example, in some aspects, the XR system 600 can include one or more other sensors (e.g., one or more inertial measurement units (IMUs), light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 6. While various components of the XR system 600, such as the image sensor 602, may be referenced in the singular form herein, it should be understood that the XR system 600 may include multiple of any component discussed herein (e.g., multiple image sensors 602).

The XR system 600 includes or is in communication with (wired or wirelessly) an input device 608. The input device 608 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, remote body sensor, handheld controller, any other input device discussed herein, or any combination thereof. In some aspects, the image sensor 602 can capture images that can be processed for interpreting gesture commands.

The XR system 600 can also communicate with one or more other electronic devices (wired or wirelessly). For example, communications engine 628 can be configured to manage connections and communicate with one or more electronic devices.

In some implementations, the one or more image sensors 602, the accelerometer 604, the gyroscope 606, storage 607, compute components 610, XR engine 620, image processing engine 624, and rendering engine 626 can be part of the same computing device. For example, in some aspects, the one or more image sensors 602, the accelerometer 604, the gyroscope 606, storage 607, compute components 610, XR engine 620, image processing engine 624, and rendering engine 626 can be integrated into an HMD, extended reality glasses, smartphone, laptop, tablet computer, gaming system, and/or any other computing device. However, in some implementations, the one or more image sensors 602, the accelerometer 604, the gyroscope 606, storage 607, compute components 610, XR engine 620, image processing engine 624, and rendering engine 626 can be part of two or more separate computing devices. For example, in some aspects, some of the components 602-626 can be part of, or implemented by, one computing device and the remaining components can be part of, or implemented by, one or more other computing devices.

The storage 607 can be any storage device(s) for storing data. Moreover, the storage 607 can store data from any of the components of the XR system 600. For example, the storage 607 can store data from the image sensor 602 (e.g., image or video data), data from the accelerometer 604 (e.g., measurements), data from the gyroscope 606 (e.g., measurements), data from the compute components 610 (e.g., processing parameters, preferences, virtual content, rendering content, scene maps, tracking and localization data, object detection data, privacy data, XR application data, face recognition data, occlusion data, etc.), data from the XR engine 620, data from the image processing engine 624, and/or data from the rendering engine 626 (e.g., output frames). In some examples, the storage 607 can include a buffer for storing frames for processing by the compute components 610.

The one or more compute components 610 can include a central processing unit (CPU) 612, a graphics processing unit (GPU) 614, a digital signal processor (DSP) 616, an image signal processor (ISP) 618, and/or other processor (e.g., a neural processing unit (NPU) implementing one or more trained neural networks). The compute components 610 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 610 can implement (e.g., control, operate, etc.) the XR engine 620, the image processing engine 624, and the rendering engine 626. In other examples, the compute components 610 can also implement one or more other processing engines.

The image sensor 602 can include any image and/or video sensors or capturing devices. In some examples, the image sensor 602 can be part of a multiple-camera assembly, such as a dual-camera assembly. The image sensor 602 can capture image and/or video content (e.g., raw image and/or video data), which can then be processed by the compute components 610, the XR engine 620, the image processing engine 624, and/or the rendering engine 626 as described herein. In some examples, the image sensors 602 may include an image capture and processing system 500, an image capture device 505A, an image processing device 505B, or a combination thereof.

In some aspects, the image sensor 602 can capture image data and can generate images (also referred to as frames) based on the image data and/or can provide the image data or frames to the XR engine 620, the image processing engine 624, and/or the rendering engine 626 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some aspects, the image sensor 602 (and/or other camera of the XR system 600) can be configured to also capture depth information. For example, in some implementations, the image sensor 602 (and/or other camera) can include an RGB-depth (RGB-D) camera. In some aspects, the XR system 600 can include one or more depth sensors (not shown) that are separate from the image sensor 602 (and/or other camera) and that can capture depth information. For instance, such a depth sensor can obtain depth information independently from the image sensor 602. In some examples, a depth sensor can be physically installed in the same general location as the image sensor 602, but may operate at a different frequency or frame rate from the image sensor 602. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 600 can also include other sensors in its one or more sensors. The one or more sensors can include one or more accelerometers (e.g., accelerometer 604), one or more gyroscopes (e.g., gyroscope 606), and/or other sensors. The one or more sensors can provide velocity, orientation, and/or other position-related information to the compute components 610. For example, the accelerometer 604 can detect acceleration by the XR system 600 and can generate acceleration measurements based on the detected acceleration. In some aspects, the accelerometer 604 can provide one or more translational vectors (e.g., up/down, left/right, forward/back) that can be used for determining a position or pose of the XR system 600. The gyroscope 606 can detect and measure the orientation and angular velocity of the XR system 600. For example, the gyroscope 606 can be used to measure the pitch, roll, and yaw of the XR system 600. In some aspects, the gyroscope 606 can provide one or more rotational vectors (e.g., pitch, yaw, roll). In some examples, the image sensor 602 and/or the XR engine 620 can use measurements obtained by the accelerometer 604 (e.g., one or more translational vectors) and/or the gyroscope 606 (e.g., one or more rotational vectors) to calculate the pose of the XR system 600. As previously noted, in other examples, the XR system 600 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some aspects, the one or more sensors can include at least one IMU. An IMU is an electronic device that measures the specific force, angular rate, and/or the orientation of the XR system 600, using a combination of one or more accelerometers, one or more gyroscopes, and/or one or more magnetometers. In some examples, the one or more sensors can output measured information associated with the capture of an image captured by the image sensor 602 (and/or other camera of the XR system 600) and/or depth information obtained using one or more depth sensors of the XR system 600.

The output of one or more sensors (e.g., the accelerometer 604, the gyroscope 606, one or more IMUs, and/or other sensors) can be used by the XR engine 620 to determine a pose of the XR system 600 (also referred to as the head pose) and/or the pose of the image sensor 602 (or other camera of the XR system 600). In some aspects, the pose of the XR system 600 and the pose of the image sensor 602 (or other camera) can be the same. The pose of image sensor 602 refers to the position and orientation of the image sensor 602 relative to a frame of reference (e.g., with respect to the scene 510 of FIG. 5). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some aspects, a device tracker (not shown) can use the measurements from the one or more sensors and image data from the image sensor 602 to track a pose (e.g., a 6DoF pose) of the XR system 600. For example, the device tracker can fuse visual data (e.g., using a visual tracking solution) from the image data with inertial data from the measurements to determine a position and motion of the XR system 600 relative to the physical world (e.g., the scene) and a map of the physical world. As described below, in some examples, when tracking the pose of the XR system 600, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 600 within the scene and the 3D map of the scene, etc. The 3D map can provide a digital representation of a scene in the real/physical world. In some examples, the 3D map can anchor location-based objects and/or content to real-world coordinates and/or objects. The XR system 600 can use a mapped scene (e.g., a scene in the physical world represented by, and/or associated with, a 3D map) to merge the physical and virtual worlds and/or merge virtual content or objects with the physical environment.

In some aspects, the pose of image sensor 602 and/or the XR system 600 as a whole can be determined and/or tracked by the compute components 610 using a visual tracking solution based on images captured by the image sensor 602 (and/or other camera of the XR system 600). For instance, in some examples, the compute components 610 can perform tracking using computer vision-based tracking, model-based tracking, and/or SLAM techniques. For instance, the compute components 610 can perform SLAM or can be in communication (wired or wireless) with a SLAM system (not shown), such as the SLAM system 700 of FIG. 7. SLAM refers to a class of techniques where a map of an environment (e.g., a map of an environment being modeled by XR system 600) is created while simultaneously tracking the pose of a camera (e.g., image sensor 602) and/or the XR system 600 relative to that map. The map can be referred to as a SLAM map, and can be three-dimensional (3D). The SLAM techniques can be performed using color or grayscale image data captured by the image sensor 602 (and/or other camera of the XR system 600), and can be used to generate estimates of 6DoF pose measurements of the image sensor 602 and/or the XR system 600. Such a SLAM technique configured to perform 6DoF tracking can be referred to as 6DoF SLAM. In some aspects, the output of the one or more sensors (e.g., the accelerometer 604, the gyroscope 606, one or more IMUs, and/or other sensors) can be used to estimate, correct, and/or otherwise adjust the estimated pose.

In some aspects, the 6DoF SLAM (e.g., 6DoF tracking) can associate features observed from certain input images from the image sensor 602 (and/or other camera) to the SLAM map. For example, 6DoF SLAM can use feature point associations from an input image to determine the pose (position and orientation) of the image sensor 602 and/or XR system 600 for the input image. 6DoF mapping can also be performed to update the SLAM map. In some aspects, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 602 and/or the XR system 600 can be determined by projecting features from the 3D SLAM map into an image or video frame and updating the camera pose from verified 2D-3D correspondences.

In one illustrative example, the compute components 610 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or any combination thereof.

As one illustrative example, the compute components 610 can extract feature points corresponding to a mobile device, or the like. In some aspects, feature points corresponding to the mobile device can be tracked to determine a pose of the mobile device. As described in more detail below, the pose of the mobile device can be used to determine a location for projection of AR media content that can enhance media content displayed on a display of the mobile device.

In some aspects, the XR system 600 can also track the hand and/or fingers of the user to allow the user to interact with and/or control virtual content in a virtual environment. For example, the XR system 600 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

In some aspects, the benefits of brightness-invariant sub-pixel estimation extend directly to XR systems such as the XR system 600 in FIG. 6. For example, the refined and brightness-corrected features obtained from the techniques in FIGS. 1-4 can be implemented by one or more compute components (e.g., CPU 612, GPU 614, DSP 616, and/or ISP 618) and integrated within the XR engine 620 or the image processing engine 624 of the XR system 600. In some examples, the XR engine 620 can more accurately maintain spatial awareness and alignment of virtual objects in dynamically lit environments. By feeding these stable, sub-pixel-accurate features into XR applications, the system reduces jitter in rendered overlays, ensures that virtual elements remain firmly anchored in the physical world, and improves overall user experience.

### Example Architecture of an SLAM System

FIG. 7 depicts a block diagram illustrating an architecture of a SLAM system 700. In some examples, the SLAM system 700 can be, or can include, an extended reality (XR) system, such as the XR system 600 of FIG. 6. In some examples, the SLAM system 700 can be a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

The SLAM system 700 of FIG. 7 includes, or is coupled to, each of one or more sensors 705. The one or more sensors 705 can include one or more cameras 710. Each of the one or more cameras 710 may include an image capture device 505A, an image processing device 505B, an image capture and processing system 500, another type of camera, or a combination thereof. Each of the one or more cameras 710 may be responsive to light from a particular spectrum of light. The spectrum of light may be a subset of the electromagnetic (EM) spectrum. For example, each of the one or more cameras 710 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or a some combination thereof.

The one or more sensors 705 can include one or more other types of sensors other than cameras 710, such as one or more of each of: accelerometers, gyroscopes, magnetometers, inertial measurement units (IMUs), altimeters, barometers, thermometers, RADAR sensors, LIDAR sensors, SONAR sensors, SODAR sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof. In some examples, the one or more sensors 705 can include any combination of sensors of the XR system 600 of FIG. 6.

The SLAM system 700 of FIG. 7 includes a visual-inertial odometry (VIO) tracker 715. The term visual-inertial odometry may also be referred to herein as visual odometry. The VIO tracker 715 receives sensor data 765 from the one or more sensors 705. For instance, the sensor data 765 can include one or more images captured by the one or more cameras 710. The sensor data 765 can include other types of sensor data from the one or more sensors 705, such as data from any of the types of sensors 705 listed herein. For instance, the sensor data 765 can include inertial measurement unit (IMU) data from one or more IMUs of the one or more sensors 705.

In some aspects, upon receipt of the sensor data 765 from the one or more sensors 705, the VIO tracker 715 performs feature detection, extraction, and/or tracking using a feature tracking engine 720 of the VIO tracker 715. For instance, where the sensor data 765 includes one or more images captured by the one or more cameras 710 of the SLAM system 700, the VIO tracker 715 can identify, detect, and/or extract features in each image. As previously described, features may include visually distinctive points in an image, such as portions of the image depicting edges and/or corners. The VIO tracker 715 can receive sensor data 765 periodically and/or continually from the one or more sensors 705, for instance by continuing to receive more images from the one or more cameras 710 as the one or more cameras 710 capture a video, where the images are video frames of the video. The VIO tracker 715 can generate descriptors for the features. Feature descriptors can be generated at least in part by generating a description of the feature as depicted in a local image patch extracted around the feature. In some examples, a feature descriptor can describe a feature as a collection of one or more feature vectors. The VIO tracker 715, In some aspects with the mapping engine 730 and/or the relocalization engine 755, can associate the plurality of features with a map of the environment based on such feature descriptors. The feature tracking engine 720 of the VIO tracker 715 can perform feature tracking by recognizing features in each image that the VIO tracker 715 already previously recognized in one or more previous images, In some aspects based on identifying features with matching feature descriptors in different images. The feature tracking engine 720 can track changes in one or more positions at which the feature is depicted in each of the different images. For example, the feature extraction engine can detect a particular corner of a room depicted in a left side of a first image captured by a first camera of the cameras 710. The feature extraction engine can detect the same feature (e.g., the same particular corner of the same room) depicted in a right side of a second image captured by the first camera. The feature tracking engine 720 can recognize that the features detected in the first image and the second image are two depictions of the same feature (e.g., the same particular corner of the same room), and that the feature appears in two different positions in the two images. The VIO tracker 715 can determine, based on the same feature appearing on the left side of the first image and on the right side of the second image that the first camera has moved, for example if the feature (e.g., the particular corner of the room) depicts a static portion of the environment.

The VIO tracker 715 can include a sensor integration engine 725. The sensor integration engine 725 can use sensor data from other types of sensors 705 (other than the cameras 710) to determine information that can be used by the feature tracking engine 720 when performing the feature tracking. For example, the sensor integration engine 725 can receive IMU data (e.g., which can be included as part of the sensor data 765) from an IMU of the one or more sensors 705. The sensor integration engine 725 can determine, based on the IMU data in the sensor data 765, that the SLAM system 700 has rotated 15 degrees in a clockwise direction from acquisition or capture of a first image and capture to acquisition or capture of the second image by a first camera of the cameras 710. Based on this determination, the sensor integration engine 725 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). The feature tracking engine 720 can take this expectation into consideration in tracking features between the first image and the second image.

Based on the feature tracking by the feature tracking engine 720 and/or the sensor integration by the sensor integration engine 725, the VIO tracker 715 can determine a 3D feature positions 773 of a particular feature. The 3D feature positions 773 can include one or more 3D feature positions and can also be referred to as 7D feature points. The 3D feature positions 773 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. The VIO tracker 715 can also determine one or more keyframes 770 (referred to hereinafter as keyframes 770) corresponding to the particular feature. A keyframe (from one or more keyframes 770) corresponding to a particular feature may be an image in which the particular feature is clearly depicted. In some examples, a keyframe (from the one or more keyframes 770) corresponding to a particular feature may be an image in which the particular feature is clearly depicted. In some examples, a keyframe corresponding to a particular feature may be an image that reduces uncertainty in the 3D feature positions 773 of the particular feature when considered by the feature tracking engine 720 and/or the sensor integration engine 725 for determination of the 3D feature positions 773. In some examples, a keyframe corresponding to a particular feature also includes data associated with the pose 785 of the SLAM system 700 and/or the camera(s) 710 during capture of the keyframe. In some examples, the VIO tracker 715 can send 3D feature positions 773 and/or keyframes 770 corresponding to one or more features to the mapping engine 730. In some examples, the VIO tracker 715 can receive map slices 775 from the mapping engine 730. The VIO tracker 715 can feature information within the map slices 775 for feature tracking using the feature tracking engine 720.

Based on the feature tracking by the feature tracking engine 720 and/or the sensor integration by the sensor integration engine 725, the VIO tracker 715 can determine a pose 785 of the SLAM system 700 and/or of the cameras 710 during capture of each of the images in the sensor data 765. The pose 785 can include a location of the SLAM system 700 and/or of the cameras 710 in 3D space, such as a set of coordinates along three different axes that are perpendicular to one another (e.g., an X coordinate, a Y coordinate, and a Z coordinate). The pose 785 can include an orientation of the SLAM system 700 and/or of the cameras 710 in 3D space, such as pitch, roll, yaw, or some combination thereof. In some examples, the VIO tracker 715 can send the pose 785 to the relocalization engine 755. In some examples, the VIO tracker 715 can receive the pose 785 from the relocalization engine 755.

In some aspects, the SLAM system 700 also includes a mapping engine 730. The mapping engine 730 generates a 3D map of the environment based on the 3D feature positions 773 and/or the keyframes 770 received from the VIO tracker 715. The mapping engine 730 can include a map densification engine 735, a keyframe remover 740, a bundle adjuster 745, and/or a loop closure detector 750. The map densification engine 735 can perform map densification, in some examples, increase the quantity and/or density of 3D coordinates describing the map geometry. The keyframe remover 740 can remove keyframes, and/or In some aspects add keyframes. In some examples, the keyframe remover 740 can remove keyframes 770 corresponding to a region of the map that is to be updated and/or whose corresponding confidence values are low. The bundle adjuster 745 can, in some examples, refine the 3D coordinates describing the scene geometry, parameters of relative motion, and/or optical characteristics of the image sensor used to generate the frames, according to an optimality criterion involving the corresponding image projections of all points. The loop closure detector 750 can recognize when the SLAM system 700 has returned to a previously mapped region, and can use such information to update a map slice and/or reduce the uncertainty in certain 3D feature points or other points in the map geometry. The mapping engine 730 can output map slices 775 to the VIO tracker 715. The map slices 775 can represent 3D portions or subsets of the map. The map slices 775 can include map slices 775 that represent new, previously-unmapped areas of the map. The map slices 775 can include map slices 775 that represent updates (or modifications or revisions) to previously-mapped areas of the map. The mapping engine 730 can output map information 780 to the relocalization engine 755. The map information 780 can include at least a portion of the map generated by the mapping engine 730. The map information 780 can include one or more 3D points making up the geometry of the map, such as one or more 3D feature positions 773. The map information 780 can include one or more keyframes 770 corresponding to certain features and certain 3D feature positions 773.

The SLAM system 700 also includes a relocalization engine 755. The relocalization engine 755 can perform relocalization, for instance when the VIO tracker 715 fail to recognize more than a threshold number of features in an image, and/or the VIO tracker 715 loses track of the pose 785 of the SLAM system 700 within the map generated by the mapping engine 730. The relocalization engine 755 can perform relocalization by performing extraction and matching using an extraction and matching engine 760. For instance, the extraction and matching engine 760 can by extract features from an image captured by the cameras 710 of the SLAM system 700 while the SLAM system 700 is at a current pose 785, and can match the extracted features to features depicted in different keyframes 770, identified by 3D feature positions 773, and/or identified in the map information 780. By matching these extracted features to the previously-identified features, the relocalization engine 755 can identify that the pose 785 of the SLAM system 700 is a pose 785 at which the previously-identified features are visible to the cameras 710 of the SLAM system 700, and is therefore similar to one or more previous poses 785 at which the previously-identified features were visible to the cameras 710. In some aspects, the relocalization engine 755 can perform relocalization based on wide baseline mapping, or a distance between a current camera position and camera position at which feature was originally captured. The relocalization engine 755 can receive information for the pose 785 from the VIO tracker 715, for instance regarding one or more recent poses of the SLAM system 700 and/or cameras 710, which the relocalization engine 755 can base its relocalization determination on. Once the relocalization engine 755 relocates the SLAM system 700 and/or cameras 710 and thus determines the pose 785, the relocalization engine 755 can output the pose 785 to the VIO tracker 715.

In some examples, the VIO tracker 715 can modify the image in the sensor data 765 before performing feature detection, extraction, and/or tracking on the modified image. For example, the VIO tracker 715 can rescale and/or resample the image. In some examples, rescaling and/or resampling the image can include downscaling, downsampling, subscaling, and/or subsampling the image one or more times. In some examples, the VIO tracker 715 modifying the image can include converting the image from color to greyscale, or from color to black and white, for instance by desaturating color in the image, stripping out certain color channel(s), decreasing color depth in the image, replacing colors in the image, or a combination thereof. In some examples, the VIO tracker 715 modifying the image can include the VIO tracker 715 masking certain regions of the image. Dynamic objects can include objects that can have a changed appearance between one image and another. For example, dynamic objects can be objects that move within the environment, such as people, vehicles, or animals. A dynamic objects can be an object that have a changing appearance at different times, such as a display screen that may display different things at different times. A dynamic object can be an object that has a changing appearance based on the pose of the camera(s) 710, such as a reflective surface, a prism, or a specular surface that reflects, refracts, and/or scatters light in different ways depending on the position of the camera(s) 710 relative to the dynamic object. The VIO tracker 715 can detect the dynamic objects using facial detection, facial recognition, facial tracking, object detection, object recognition, object tracking, or a combination thereof. The VIO tracker 715 can detect the dynamic objects using one or more artificial intelligence algorithms, one or more trained machine learning models, one or more trained neural networks, or a combination thereof. The VIO tracker 715 can mask one or more dynamic objects in the image by overlaying a mask over an area of the image (e.g., placing the mask as if covering a portion of the image) that includes depiction(s) of the one or more dynamic objects. The mask can be an opaque color, such as black. The area can be a bounding box having a rectangular or other polygonal shape. The area can be determined on a pixel-by-pixel basis.

In some aspects, feature detectors, such as those of the VIO tracker 715 may detect features based primarily on visually distinctive points in the image corresponding to corners. Using corner features for SLAM works well in environments with lots of corners, but issues (e.g., jitter, artifacts, etc.) can arise in environments with few or no visible corners. In some aspects, it may be useful to use direct tracking techniques for feature tracking for SLAM/6DoF. In some aspects, direct feature tracking may involve feature tracking with high gradient image pixels and direct feature tracking may track corners as well as unidirectional local image gradients.

As depicted in FIG. 7, the SLAM system 700 may benefit from the brightness-invariant sub-pixel refinements discussed in FIGS. 1-4. Precisely localized edge features can act as anchor points in constructing and updating 3D maps. By integrating these refined features into the VIO tracker 715 and/or the mapping engine 730, the SLAM system can achieve more reliable camera pose estimation and smoother navigation through challenging conditions.

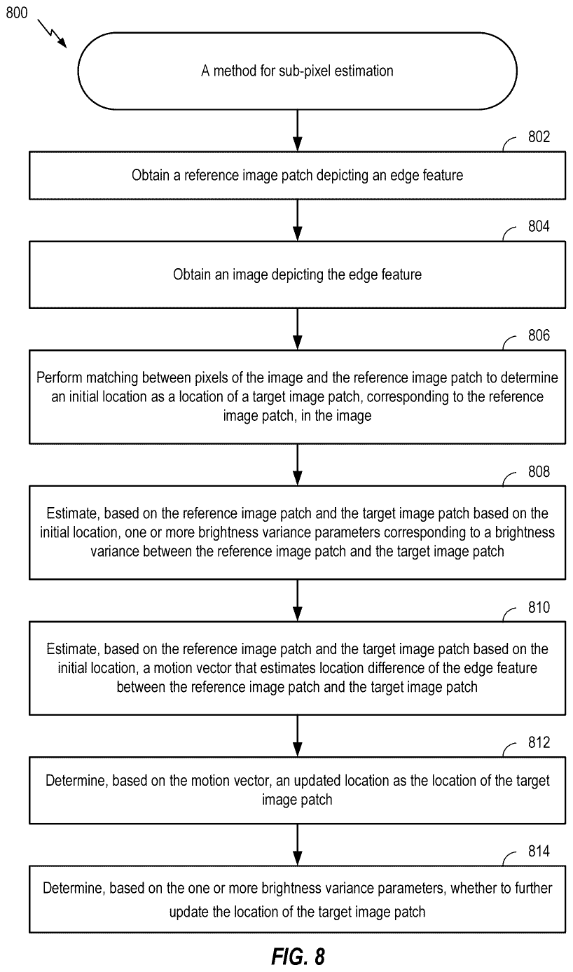

FIG. 8 depicts a method 800 directed to performing sub-pixel estimation in accordance with aspects of the present disclosure. The method 800, or any aspect related to it, may be performed by an apparatus, such as processing system 900 of FIG. 9, which includes various components operable, configured, or adapted to perform the method 800.

Method 800 begins at bock 802 with obtaining a reference image patch depicting an edge feature. As described with respect to FIG. 1, the reference image patch 104 may be extracted from a reference image 102 and may contain distinctive visual elements like edges that can be tracked across different frames.

Method 800 then proceeds to block 804 with obtaining an image depicting the edge feature. As described with respect to FIG. 1, a target image 108 may be obtained, where the target image 108 may contain the same edge feature but potentially under different lighting conditions or from a different viewpoint.

Method 800 then proceeds to block 806 with performing matching between pixels of the image and the reference image patch to determine an initial location as a location of a target image patch, corresponding to the reference image patch, in the image. As described with respect to FIG. 1, the matching engine 114 may perform matching using techniques like normalized cross-correlation to find a target image patch 110 that best matches the reference image patch 104, and then provides a target image patch location 116.

Method 800 then proceeds to block 808 with estimating, based on the reference image patch and the target image patch based on the initial location, one or more brightness variance parameters corresponding to a brightness variance between the reference image patch and the target image patch. As described with respect to FIGS. 2-3, such estimation may be performed either sequentially by the brightness parameter estimator 204 or jointly by the joint brightness parameter & motion vector estimator 304 to account for illumination differences between the patches.

Method 800 then proceed to block 810 with estimating, based on the reference image patch and the target image patch based on the initial location, a motion vector based on the initial location and an intensity difference between the reference image patch and the target image patch. In some aspects, the motion vector 124 may be computed by either the motion vector estimator 206 in FIG. 2 or jointly estimated by the motion vector estimator 304 in FIG. 3.

Method 800 then proceeds to block 812 with determining, based on the motion vector, an updated location as the location of the target image patch. As shown in FIGS. 2-3, an updated target image patch location 126 with sub-pixel accuracy may be obtained.

Method 800 then proceeds to block 814 with determining, based on the one or more brightness variance parameters, whether to further update the location of the target image patch. As depicted in FIGS. 2-3, the error estimator 210 may evaluate whether the corrected target image patch sufficiently matches the reference patch or if further refinement iterations may be needed.

In some aspects, method 800 further includes determining an edge gradient direction of the edge feature based on the target image patch based on the initial location, wherein estimating the motion vector comprises estimating the motion vector further based on constraint of a direction of the motion vector based on the edge gradient direction.

In some aspects of method 800, the initial location is a pixel level location; and the updated location is a sub-pixel level location.

In some aspects of method 800, estimating the motion vector comprises estimating the motion vector further based on motion estimation.

In some aspects of method 800, the motion estimation comprises Lucas-Kanade optical flow estimation or efficient second-order minimization (ESM).

In some aspects of method 800, determining, based on the one or more brightness variance parameters, whether to further update the location of the target image patch comprises: determining whether a difference in intensity values between the reference image patch and a corrected target image patch can be further reduced, wherein the corrected target image patch is based on the target image patch at the updated location and the one or more brightness variance parameters.

In some aspects of method 800, estimating the one or more brightness variance parameters and the motion vector comprises estimating the one or more brightness variance parameters and the motion vector jointly.

In some aspects of method 800, estimating the one or more brightness variance parameters and the motion vector, comprises: estimating the one or more brightness variance parameters; determining a corrected target image patch at the initial location based on the target image patch at the initial location and the one or more brightness variance parameters; and estimating the motion vector based on the reference image patch and the corrected target image patch at the initial location.

In some aspects, method 800 further comprises: determining for each of a plurality of locations for the target image patch in the image, a corresponding correlation score, of a plurality of correlation scores, between the reference image patch and the target image patch at the corresponding location; fitting a parabola to the plurality of correlation scores; and determining a new location as the location of the target image patch based on a maxima of the parabola.

In some aspects, method 800 further comprises: determining the new location is outside a range; and estimating the one or more brightness variance parameters and the motion vector comprises estimating the one or more brightness variance parameters and the motion vector in response to the determination the new location is outside the range.

In some aspects, method 800 further comprises performing one or more of the following based on the updated location of the target image patch: performing object recognition based on the location of the edge feature in the target image path; determining a motion trajectory of the edge feature; generating a mapping of an environment based on a motion trajectory of the edge feature; estimating a relative location of an object in the target image; or enhancing an alignment accuracy for subsequent image processing tasks.

Note that the process flow illustrated in FIG. 8 is an example of brightness-invariant sub-pixel estimation technique, and aspects of the present disclosure may be applied to various feature tracking and computer vision applications. Note that the process flow illustrated in FIG. 8 is described herein to facilitate an understanding of brightness-invariant sub-pixel estimation techniques, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Processing System for Performing Sub-Pixel Estimation

FIG. 9 depicts aspects of an example processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it, including any additional steps or sub-steps described in relation to FIG. 8.

In the depicted example, computer-readable medium/memory 930 stores code (e.g., executable instructions) for obtaining 931, code for performing 932, code for estimating 933, and code for determining 934. Processing of the code 931-934 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry for obtaining 921, circuitry for performing 922, circuitry for estimating 923, and circuitry for determining 924. Processing with circuitry 921-924 may enable and cause the processing system 900 to perform the method 800 described with respect to FIG. 8, or any aspect related to it.

### Example Clauses

Implementation examples are described in the following numbered clauses:

Clause 1: A method for sub-pixel estimation, comprising: obtaining a reference image patch depicting an edge feature; obtaining an image depicting the edge feature; performing matching between pixels of the image and the reference image patch to determine an initial location as a location of a target image patch, corresponding to the reference image patch, in the image; estimating, based on the reference image patch and the target image patch based on the initial location, one or more brightness variance parameters corresponding to a brightness variance between the reference image patch and the target image patch; estimating, based on the reference image patch and the target image patch based on the initial location, a motion vector based on the initial location and an intensity difference between the reference image patch and the target image patch; determining, based on the motion vector, an updated location as the location of the target image patch; and determining, based on the one or more brightness variance parameters, whether to further update the location of the target image patch.

Clause 2: The method of Clause 1, furthering comprising: determining an edge gradient direction of the edge feature based on the target image patch based on the initial location, wherein estimating the motion vector comprises estimating the motion vector based on constraint of a direction of the motion vector based on the edge gradient direction.

Clause 3: The method of any one of Clauses 1-2, wherein: the initial location is a pixel level location; and the updated location is a sub-pixel level location.

Clause 4: The method of any one of Clauses 1-3, wherein estimating the motion vector comprises estimating the motion vector further based on motion estimation.

Clause 5: The method of Clause 4, wherein the motion estimation comprises Lucas-Kanade optical flow estimation or efficient second-order minimization (ESM).

Clause 6: The method of any one of Clauses 1-5, wherein determining, based on the one or more brightness variance parameters, whether to further update the location of the target image patch, comprises determining whether a difference in intensity values between the reference image patch and a corrected target image patch can be further reduced, wherein the corrected target image patch is based on the target image patch at the updated location and the one or more brightness variance parameters.

Clause 7: The method of any one of Clauses 1-5, wherein estimating the one or more brightness variance parameters and the motion vector comprises estimating the one or more brightness variance parameters and the motion vector jointly.

Clause 8: The method of any one of Clauses 1-7, wherein estimating the one or more brightness variance parameters and the motion vector comprises: estimating the one or more brightness variance parameters; determining a corrected target image patch at the initial location based on the target image patch at the initial location and the one or more brightness variance parameters; and estimating the motion vector based on the reference image patch and the corrected target image patch at the initial location.

Clause 9: The method of any one of Clauses 1-8, further comprising: determining, for each of a plurality of locations for the target image patch in the image, a corresponding correlation score of a plurality of correlation scores, between the reference image patch and the target image patch at the corresponding location; fitting a parabola to the plurality of correlation scores; and determining a new location as the location of the target image patch based on a maxima of the parabola.

Clause 10: The method of Clause 9, wherein the plurality of correlation scores are estimated at a plurality of locations, on one or both sides of the initial location, along a direction perpendicular to the edge feature.

Clause 11: The method of any one of Clauses 1-10, further comprising: determining the new location is outside a range, wherein estimating the one or more brightness variance parameters and the motion vector comprises estimating the one or more brightness variance parameters and the motion vector in response to the determination the new location is outside the range.

Clause 12: The method of any one of Clauses 1-11, further comprising performing at least one of the following: performing object recognition based on the location of the edge feature in the target image patch; determining a motion trajectory of the edge feature; generating a mapping of an environment based on a motion trajectory of the edge feature; estimating a relative location of an object in the target image patch; or enhancing an alignment accuracy for subsequent image processing tasks.

Clause 13: The method of any one of Clauses 1-12, further comprising: estimating the motion vector using at least one sub-pixel estimation technique based on at least one of a power consumption threshold or an accuracy threshold.

Clause 14: An apparatus, comprising: a memory comprising executable instructions; and a processor configured to execute the executable instructions and cause the apparatus to perform a method in accordance with any one of clauses 1-13.

Clause 15: An apparatus, comprising means for performing a method in accordance with any one of clauses 1-13.

Clause 16: A non-transitory computer-readable medium storing program code for causing a processing system to perform the steps of any one of clauses 1-13.

Clause 17: A computer program product embodied on a computer-readable storage medium comprising code for performing a method in accordance with any one of clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for sub-pixel estimation, comprising:
a hardware circuit configured to:
obtain a reference image patch depicting an edge feature;
obtain an image depicting the edge feature;
perform matching between pixels of the image and the reference image patch to determine an initial location as a location of a target image patch, corresponding to the reference image patch, in the image;
estimate, based on the reference image patch and the target image patch based on the initial location, one or more brightness variance parameters corresponding to a brightness variance between the reference image patch and the target image patch;
estimate, based on the reference image patch and the target image patch based on the initial location, a motion vector based on the initial location and an intensity difference between the reference image patch and the target image patch;
determine, based on the motion vector, an updated location as the location of the target image patch; and
determine, based on the one or more brightness variance parameters, whether to further update the location of the target image patch.

2. The apparatus of claim 1, wherein:
the hardware circuit is configured to determine an edge gradient direction of the edge feature based on the target image patch based on the initial location; and
to estimate the motion vector, the hardware circuit is configured to estimate the motion vector further based on constraint of a direction of the motion vector based on the edge gradient direction.

3. The apparatus of claim 1, wherein:
the initial location is a pixel level location; and
the updated location is a sub-pixel level location.

4. The apparatus of claim 1, wherein:
to estimate the motion vector, the hardware circuit is configured to estimate the motion vector further based on motion estimation.

5. The apparatus of claim 4, wherein the motion estimation comprises Lucas-Kanade optical flow estimation or efficient second-order minimization (ESM).

6. The apparatus of claim 1, wherein to determine, based on the one or more brightness variance parameters, whether to further update the location of the target image patch, the hardware circuit is configured to:
determine whether a difference in intensity values between the reference image patch and a corrected target image patch can be further reduced, wherein the corrected target image patch is based on the target image patch at the updated location and the one or more brightness variance parameters.

7. The apparatus of claim 1, wherein to estimate the one or more brightness variance parameters and the motion vector, the hardware circuit is configured to estimate the one or more brightness variance parameters and the motion vector jointly.

8. The apparatus of claim 1, wherein to estimate the one or more brightness variance parameters and the motion vector, the hardware circuit is configured to:
estimate the one or more brightness variance parameters;
determine a corrected target image patch at the initial location based on the target image patch at the initial location and the one or more brightness variance parameters; and
estimate the motion vector based on the reference image patch and the corrected target image patch at the initial location.

9. The apparatus of claim 1, wherein the hardware circuit is configured to:
determine, for each of a plurality of locations for the target image patch in the image, a corresponding correlation score, of a plurality of correlation scores, between the reference image patch and the target image patch at the corresponding location;
fit a parabola to the plurality of correlation scores; and
determine a new location as the location of the target image patch based on a maxima of the parabola.

10. The apparatus of claim 9, wherein the plurality of correlation scores are estimated at a plurality of locations, on one or both sides of the initial location, along a direction perpendicular to the edge feature.

11. The apparatus of claim 9, wherein:
the hardware circuit is configured to determine the new location is outside a range; and
to estimate the one or more brightness variance parameters and the motion vector, the hardware circuit is configured to estimate the one or more brightness variance parameters and the motion vector in response to the determination the new location is outside the range.

12. The apparatus of claim 1, wherein based on the updated location of the target image patch, the hardware circuit is configured to perform at least one of the following:
perform object recognition based on the location of the edge feature in the target image patch;
determine a motion trajectory of the edge feature;
generate a mapping of an environment based on a motion trajectory of the edge feature;
estimate a relative location of an object in the target image patch; or
enhance an alignment accuracy for subsequent image processing tasks.

13. The apparatus of claim 1, wherein the hardware circuit is configured to estimate the motion vector using at least one sub-pixel estimation technique based on at least one of a power consumption threshold or an accuracy threshold.

14. A method for sub-pixel estimation, comprising:
obtaining a reference image patch depicting an edge feature;
obtaining an image depicting the edge feature;
performing matching between pixels of the image and the reference image patch to determine an initial location as a location of a target image patch, corresponding to the reference image patch, in the image;
estimating, based on the reference image patch and the target image patch based on the initial location, one or more brightness variance parameters corresponding to a brightness variance between the reference image patch and the target image patch;
estimating, based on the reference image patch and the target image patch based on the initial location, a motion vector based on the initial location and an intensity difference between the reference image patch and the target image patch;
determining, based on the motion vector, an updated location as the location of the target image patch; and
determining, based on the one or more brightness variance parameters, whether to further update the location of the target image patch.

15. The method of claim 14, furthering comprising:
determining an edge gradient direction of the edge feature based on the target image patch based on the initial location, wherein estimating the motion vector comprises estimating the motion vector based on constraint of a direction of the motion vector based on the edge gradient direction.

16. The method of claim 14, wherein:
the initial location is a pixel level location; and
the updated location is a sub-pixel level location.

17. The method of claim 14, wherein estimating the motion vector comprises estimating the motion vector further based on motion estimation.

18. The method of claim 14, wherein determining, based on the one or more brightness variance parameters, whether to further update the location of the target image patch, comprises determining whether a difference in intensity values between the reference image patch and a corrected target image patch can be further reduced, wherein the corrected target image patch is based on the target image patch at the updated location and the one or more brightness variance parameters.

19. The method of claim 14, wherein estimating the one or more brightness variance parameters and the motion vector comprises estimating the one or more brightness variance parameters and the motion vector jointly.

20. The method of claim 14, further comprising:
determining, for each of a plurality of locations for the target image patch in the image, a corresponding correlation score of a plurality of correlation scores, between the reference image patch and the target image patch at the corresponding location;
fitting a parabola to the plurality of correlation scores; and
determining a new location as the location of the target image patch based on a maxima of the parabola.
